(19) United States
(12) Patent Application Publication
(10) Pub. No.: US 2025/0043398 A1
(43) Pub. Date: Feb. 6, 2025

(54) NON-ORIENTED ELECTRICAL STEEL SHEET AND METHOD FOR MANUFACTURING THE SAME

(71) Applicant: JFE Steel Corporation, Chiyoda-ku, Tokyo (JP)

(72) Inventors: Takaaki TANAKA, Chiyoda-ku, Tokyo (JP); Tomoyuki OKUBO, Chiyoda-ku, Tokyo (JP)

(73) Assignee: JFE Steel Corporation, Chiyoda-ku, Tokyo (JP)

(21) Appl. No.: 18/717,489

(22) PCT Filed: Dec. 12, 2022
(86) PCT No.: PCT/JP2022/045664

§ 371 Date: Jun. 7, 2024

(30) Foreign Application Priority Data
Dec. 16, 2021 (JP) 2021-203933

(51) Int. Cl. C22C 38/02; C21D 6/00; C21D 8/02; C21D 9/46; C22C 38/00; C22C 38/04; C22C 38/06

(52) U.S. Cl. CPC C22C 38/02; C21D 6/008; C21D 8/0205; C21D 8/0226; C21D 8/0236; C21D 8/0263; C21D 8/0273; C21D 9/46; C22C 38/001; C22C 38/002; C22C 38/004; C22C 38/04; C22C 38/06; C21D 2201/05

(57) ABSTRACT

A non-oriented electrical steel sheet includes, by mass %, C: 0.010% or less, Si: 1.0% or more and 5.0% or less, Mn: 0.05% or more and 5.0% or less, P: 0.1% or less, S: 0.01% or less, Al: 3.0% or less, N: 0.005% or less, and the balance being Fe and inevitable impurities, wherein an average crystal grain size is 60 μm or more and 200 μm or less, and a sum S_{A} of area ratios of crystal grains with <100> oriented in a rolling direction or a direction perpendicular to the rolling direction and a sum S_{B} of area ratios of crystal grains with <111> oriented in the rolling direction or the direction perpendicular to the rolling direction satisfy S_{A}−S_{B}≥0.

### CROSS REFERENCE TO RELATED APPLICATIONS

This is the U.S. National Phase application of PCT/JP2022/045664, filed Dec. 12, 2022, which claims priority to Japanese Patent Application No. 2021-203933, filed Dec. 16, 2021, the disclosures of these applications being incorporated herein by reference in their entireties for all purposes.

### FIELD OF THE INVENTION

The present invention relates to a non-oriented electrical steel sheet and a method for manufacturing the same.

### BACKGROUND OF THE INVENTION

In recent years, reduction of CO₂ emission and energy saving have been required in consideration of environmental problems such as global warming, and in the automobile field, hybrid electric vehicles (HEV) using both an engine and a motor, electric vehicles (EV) and fuel cell electric vehicles (FCEV) driven only by an electric motor, and the like have been developed. The motors used for the HEV, EV, FCEV, and the like are normally driven in a high frequency range advantageous for high-speed rotation in order to increase the efficiency of the motors. A non-oriented electrical steel sheet is often used as an iron core material of the motor, and to achieve high efficiency of motor efficiency, the steel sheet is strongly required to have low iron losses in a high frequency range.

Conventionally, a non-oriented electrical steel sheet has been intended to reduce iron losses by increasing specific resistance mainly by adding an alloy element such as Si or A1 or reducing eddy current loss by reducing a sheet thickness. However, addition of a large amount of an alloy element leads to a decrease in saturation magnetic flux density even when iron losses can be reduced. A decrease in saturation magnetic flux density leads to an increase in copper loss of the motor, leading to a decrease in motor efficiency. In addition, the decrease in the sheet thickness leads to a decrease in productivity because it is necessary to reduce the sheet thickness of the hot-rolled steel sheet or to increase the cold rolling reduction ratio. Therefore, if a non-oriented electrical steel sheet having a high magnetic flux density and a high-frequency low iron loss without causing a decrease in saturation magnetic flux density and a decrease in productivity can be developed, it is considered to greatly contribute to an increase in efficiency of the motor.

As a technique for obtaining a non-oriented electrical steel sheet having low iron loss in a high frequency range, for example, Patent Literature 1 discloses a method for increasing the specific resistance of steel by adding Cr and reducing iron losses in a high frequency range.

### PATENT LITERATURE

Patent Literature 1: JP H11-343544 A

### SUMMARY OF THE INVENTION

However, Cr is an element that reduces the saturation magnetic flux density. Thus, the technique disclosed in Patent Literature 1 cannot achieve both high magnetic flux density and low iron loss in a high frequency, and cannot sufficiently meet the recent demand for non-oriented electrical steel sheets.

Aspects of the present invention have been made to solve the above problems, and an object of aspects of the present invention is to provide a non-oriented electrical steel sheet having a high magnetic flux density and a high-frequency low iron loss without causing a decrease in saturation magnetic flux density and a decrease in productivity, and a method for manufacturing the same.

The inventors of the present invention have extensively conducted studies for solving the above-described problems, and found that a non-oriented electrical steel sheet having a high magnetic flux density and low iron loss in a high frequency range can be obtained by controlling a steel sheet structure such that a sum S_{A} of area ratios of crystal grains with <100> oriented in a rolling direction or a direction perpendicular to the rolling direction and a sum S_{B} of area ratios of crystal grains with <111> oriented in the rolling direction or the direction perpendicular to the rolling direction satisfy S_{A}−S_{B}≥0. Further, the inventors of the present invention have also found that the area ratio of crystals facing a specific orientation can be controlled by setting the rapid heat stop temperature, the intermediate retention time, and the like at the time of heating in the annealing step within appropriate ranges.

Aspects of the present invention have been made based on such findings, and include the following configurations.

To solve the problem and achieve the object, a non-oriented electrical steel sheet according to aspects of the present invention includes, by mass %, C: 0.010% or less, Si: 1.0% or more and 5.0% or less, Mn: 0.05% or more and 5.0% or less, P: 0.1% or less, S: 0.01% or less, Al: 3.0% or less, N: 0.005% or less, and the balance being Fe and inevitable impurities, wherein an average crystal grain size is 60 μm or more and 200 μm or less, and a sum S_{A} of area ratios of crystal grains with <100> oriented in a rolling direction or a direction perpendicular to the rolling direction and a sum S_{B} of area ratios of crystal grains with <111> oriented in the rolling direction or the direction perpendicular to the rolling direction satisfy S_{A}−S_{B}≥0.

Moreover, in the non-oriented electrical steel sheet, a sum S_{C} of area ratios of crystal grains with <100> oriented in a rolling 45° direction and a rolling −45° direction and a sum S_{D} of area ratios of crystal grains with <111> oriented in the rolling 45° direction and the rolling-45° direction may satisfy 5×S_{C}−S_{D}≥0.

Moreover, the non-oriented electrical steel sheet may further include Co in an amount of 0.0005% or more and 0.0050% or less by mass %.

Moreover, the non-oriented electrical steel sheet may further include Zn in an amount of 0.0005% or more and 0.0050% or less by mass %.

Moreover, the non-oriented electrical steel sheet may further include, by mass %, at least one component selected from Groups A to D shown below and one or two or more selected from the group selected from Cu: 0% or more and 0.5% or less, Ni: 0% or more and 0.5% or less, W: 0% or more and 0.05% or less, Ti: 0% or more and 0.005%, Nb: 0% or more and 0.005% or less, V: 0% or more and 0.010% or less, Ta: 0% or more and 0.002% or less, B: 0% or more and 0.002% or less, Ga: 0% or more and 0.005% or less, Pb: 0% or more and 0.002% or less, As: 0% or more and 0.05% or less, and Ge: 0% or more and 0.05% or less.

⋅Group A; Mo: 0.01% or more and 0.20% or less, ⋅Group B; Cr: 0.1% or more and 5.0% or less, ⋅Group C; Any one or two or more of Ca: 0.001% or more and 0.10% or less, Mg: 0.001% or more and 0.10% or less, and REM: 0.001% or more and 0.10% or less, ⋅Group D; Any one or two of Sn: 0.001% or more and 0.20% or less and Sb: 0.001% or more and 0.20% or less.

Moreover, a method for manufacturing a non-oriented electrical steel sheet according to aspects of the present invention is the method for manufacturing the non-oriented electrical steel sheet according to aspects of the present invention. The method includes: a hot rolling step of subjecting a steel material having a composition of the non-oriented electrical steel sheet to hot rolling to obtain a hot rolled sheet; a hot-rolled sheet annealing step of subjecting the hot-rolled sheet to hot-rolled sheet annealing as necessary; a pickling step of subjecting the hot-rolled sheet and the hot-rolled sheet subjected to the hot-rolled sheet annealing to pickling; a cold rolling step of subjecting the hot-rolled sheet subjected to the pickling to cold rolling to obtain a cold-rolled sheet; and an annealing step of heating the cold-rolled sheet to an annealing temperature of T₂ of 875° C. or higher and 1050° C. or lower and cooling the sheet to obtain a cold-rolled and annealed sheet under conditions of an average temperature rising rate V₁ of 50° C./s or more, from 200° C. to a holding temperature T₁ of 400° C. or higher and 600° C. or lower, a holding time t of 1 second or more and 10 seconds or less, at the holding temperature T₁, and an average temperature rising rate V₂ of 15° C./s or more, from the holding temperature T₁ to 750° C.

Moreover, the cold rolling step may be performed under conditions of a work roll diameter of a final pass of 150 mm ϕ or more, a rolling reduction ratio of the final pass of 15% or more, and a strain rate of the final pass of 100 s⁻¹ or more and 1300 s⁻¹ or less.

According to aspects of the present invention, a non-oriented electrical steel sheet having a high magnetic flux density and a high-frequency low iron loss without causing a decrease in saturation magnetic flux density and a decrease in productivity, and a method for manufacturing the same can be provided. Thus, using the non-oriented electrical steel sheet and the method for manufacturing the same according to aspects of the present invention makes it possible to achieve high efficiency of a motor. Even when the non-oriented electrical steel sheet according to aspects of the present invention is subjected to stress-relief annealing for the purpose of reducing an increase in iron loss due to distortion at the time of punching, the above effect is not affected at all.

### DETAILED DESCRIPTION OF EMBODIMENTS OF THE INVENTION

Hereinafter, the details of embodiments of the present invention will be described together with the reasons for limitation.

### <Component Composition of Steel Sheet>

First, a preferred component composition of a non-oriented electrical steel sheet (hereinafter, abbreviated as “steel sheet”) and a motor core according to aspects of the present invention will be described. The unit of the content of the elements in the component composition is “mass %” in each case, and hereinafter, it is simply referred to as “%” unless otherwise specified.

### C: 0.010% or Less

C is a harmful element that forms carbide during use of a motor, causes magnetic aging, and deteriorates iron loss characteristics of the motor. To avoid magnetic aging, C contained in the steel sheet is set to 0.010% or less. The content is preferably 0.004% or less. The lower limit of the addition amount of C is not particularly specified, but it is preferable to set the lower limit to about 0.0001% because the steel sheet in which C is excessively reduced is very expensive.

### Si: 1.0% or More and 5.0% or Less

Si has an effect of increasing the specific resistance of steel and reducing iron losses, and has an effect of increasing the strength of steel through solid solution strengthening. To obtain such an effect, the addition amount of Si may be 1.0% or more. On the other hand, when the addition amount of Si exceeds 5.0%, the magnetic flux density remarkably decreases as the saturation magnetic flux density decreases, and thus the upper limit is set to 5.0% or less. Thus, the addition amount of Si is in a range of 1.0% or more and 5.0% or less. The addition amount is preferably in a range of 1.5% or more and less than 4.5%, and more preferably in a range of 2.0% or more and less than 4.0%.

### Mn: 0.05% or More and 5.0% or Less

Mn is, like Si, a useful element for increasing the specific resistance and strength of steel. To obtain such an effect, it is necessary to contain Mn in an amount of 0.05% or more. On the other hand, addition of more than 5.0% may promote precipitation of MnC to deteriorate the magnetic properties of the motor, and thus the upper limit is set to 5.0%. Thus, the addition amount of Mn is 0.05% or more and 5.0% or less. The amount is preferably in a range of 0.1% or more and 3.0% or less.

### P: 0.1% or Less

P is a useful element used for adjusting the strength (hardness) of steel. However, when the addition amount of P exceeds 0.1%, toughness decreases and cracking easily occurs during processing, and thus the upper limit is set to 0.1%. The lower limit is not particularly specified, but the lower limit is set to 0.001% because the steel sheet in which P is excessively reduced is very expensive. The addition amount of P is preferably in a range of 0.003% or more and 0.08% or less.

### S: 0.01% or Less

S is an element that forms fine precipitates and adversely affects the iron loss characteristics of the motor. In particular, when the addition amount of S exceeds 0.01%, the adverse effect becomes significant, and thus the upper limit is set to 0.01%. The lower limit is not particularly specified, but the lower limit is set to 0.0001% because the steel sheet in which S is excessively reduced is very expensive. The addition amount of S is preferably in a range of 0.0003% or more and 0.0080% or less.

Al: 3.0% or less

Al is, like Si, a useful element having an effect of increasing specific resistance of steel and reducing iron losses. To obtain such an effect, it is preferable to add Al in an amount of 0.005% or more. The amount is more preferably 0.010% or more, still more preferably 0.015% or more. On the other hand, addition of more than 3.0% promotes nitriding of the steel sheet surface and may deteriorate magnetic properties, and thus the upper limit is set to 3.0%. The amount is more preferably 2.0% or less.

### N: 0.0050% or Less

N is an element that forms fine precipitates and adversely affects iron loss characteristics. In particular, when the addition amount of N exceeds 0.0050%, the adverse effect becomes significant, and thus the upper limit is set to 0.0050%. The lower limit is not particularly specified, but the lower limit is set to 0.0005% because the steel sheet in which N is excessively reduced is very expensive. The addition amount of N is preferably in a range of 0.0008% or more and 0.0030% or less.

In the non-oriented electrical steel sheet according to aspects of the present invention, the balance other than the above components is Fe and inevitable impurities. Further, according to the required characteristics, in addition to the above component composition, one or two or more selected from Co, Zn, Mo, Cr, Ca, Mg, REM, Sn, Sb, Cu, Ni, W, Ti, Nb, V, Ta, B, Ga, Pb, As, and Ge can be contained in the following ranges.

### Co: 0.0005% or More and 0.0050% or Less

Co has an effect of increasing the sum S_{A} of the area ratios of the crystal grains with <100> oriented in a rolling direction or a direction perpendicular to the rolling direction and decreasing the sum S_{B} of the area ratios of the crystal grains with <111> oriented in the rolling direction or the direction perpendicular to the rolling direction when the rapid heat stop temperature, the intermediate holding time, and the like at the time of heating in the annealing step are set to an appropriate range. That is, S_{A}−S_{B}≥0 can be stably realized by adding a trace amount of Co. To obtain such an effect, the addition amount of Co may be 0.0005% or more. On the other hand, when Co exceeds 0.0050%, the effect reaches saturation and the cost unnecessarily increases, and thus the upper limit is set to 0.0050%. Thus, Co is preferably added in a range of 0.0005% or more and 0.0050% or less.

### Zn: 0.0005% or More and 0.0050% or Less

Zn has an effect of increasing the sum S_{C} of the area ratios of the crystal grains with <100> oriented in a rolling 45° direction and a rolling −45° direction and decreasing the sum S_{D} of the area ratios of the crystal grains with <111> oriented in the rolling 45° direction and the rolling −45° direction when the rapid heat stop temperature, the intermediate holding time, and the like at the time of heating in the annealing step are set to an appropriate range. That is, 5×S_{C}−S_{D}≥0 can be stably realized by adding a trace amount of Zn. To obtain such an effect, the addition amount of Zn may be 0.0005% or more. On the other hand, when Zn exceeds 0.0050%, the effect reaches saturation and the cost unnecessarily increases, and thus the upper limit is set to 0.0050%. Thus, Zn is preferably added in a range of 0.0005% or more and 0.0050% or less.

### Mo: 0.01% or More and 0.20% or Less

Mo has an effect of forming fine carbides in steel to increase the strength of the steel sheet. To obtain such an effect, the addition amount of Mo may be 0.01% or more. On the other hand, when the addition amount of Mo exceeds 0.20%, carbides are excessively formed to deteriorate iron loss, and thus the upper limit is set to 0.20%. Thus, Mo is preferably added in a range of 0.01% or more and 0.20% or less.

### Cr: 0.1% or More and 5.0% or Less

Cr has an effect of increasing specific resistance of steel and reducing iron loss. To obtain such an effect, the addition amount of Cr may be 0.1% or more. On the other hand, when the addition amount of Cr exceeds 0.1%, the magnetic flux density remarkably decreases as the saturation magnetic flux density decreases, and thus the upper limit is set to 5.0%. Thus, Cr is preferably added in a range of 0.1% or more and 5.0% or less.

### Ca: 0.001% or More and 0.10% or Less

Ca is an element that fixes S as a sulfide and contributes to reduction of iron loss. To obtain such an effect, the addition amount of Ca may be 0.001% or more. On the other hand, when the addition amount of Ca exceeds 0.10%, the effect reaches saturation and the cost unnecessarily increases, and thus the upper limit is set to 0.10%. Thus, Ca is preferably added in a range of 0.001% or more and 0.10% or less.

### Mg: 0.001% or More and 0.10% or Less

Mg is an element that fixes S as a sulfide and contributes to reduction of iron loss. To obtain such an effect, the addition amount of Mg may be 0.001% or more. On the other hand, when the addition amount of Mg exceeds 0.10%, the effect reaches saturation and the cost unnecessarily increases, and thus the upper limit is set to 0.10%. Thus, Mg is preferably added in a range of 0.001% or more and 0.10% or less.

### REM: 0.001% or More and 0.10% or Less

REM is an element group that fixes S as sulfide and contributes to reduction of iron losses. To obtain such an effect, the addition amount of REM may be 0.001% or more. On the other hand, when the addition amount of REM exceeds 0.10%, the effect reaches saturation and the cost unnecessarily increases, and thus the upper limit is set to 0.10%. Thus, REM is preferably added in a range of 0.001% or more and 0.10% or less.

### Sn: 0.001% or More and 0.20% or Less

Sn is an element effective for improving the magnetic flux density and reducing iron losses by improving the texture. To obtain such an effect, the addition amount of Sn may be 0.001% or more. On the other hand, when the addition amount of Sn exceeds 0.20%, the effect reaches saturation and the cost unnecessarily increases, and thus the upper limit is set to 0.20%. Thus, Sn is preferably added in a range of 0.001% or more and 0.20% or less.

### Sb: 0.001% or More and 0.20% or Less

Sb is an element effective for improving the magnetic flux density and reducing iron losses by improving the texture. To obtain such an effect, the addition amount of Sb may be 0.001% or more. On the other hand, when the addition amount of Sb exceeds 0.20%, the effect reaches saturation and the cost unnecessarily increases, and thus the upper limit is set to 0.20%. Thus, Sb is preferably added in a range of 0.001% or more and 0.20% or less.

### Cu: 0% or More and 0.5% or Less, Ni: 0% or More and 0.5% or Less

Cu and Ni are elements that improve the toughness of steel, and can be appropriately added. However, when the addition amount exceeds 0.5%, the above effect reaches saturation, and thus the upper limit of the addition amount is preferably set to 0.5% for each. More preferably, the addition amount is in a range of 0.01% or more and 0.1% or less.

### W: 0% or More and 0.05% or Less

W can be appropriately added because it forms fine carbides and improves punch fatigue strength by enhancing the steel sheet strength through precipitation strengthening. On the other hand, when the addition amount exceeds the above range, carbides excessively form, and the iron losses deteriorate. Thus, the addition amount of W is in a range of 0% or more and 0.05% or less. The upper limit of the addition amount is preferably 0.02%.

### Ti: 0% or More and 0.005% or Less, Nb: 0% or More and 0.005% or Less, V: 0% or More and 0.010% or Less, and Ta: 0% or More and 0.002% or Less

Ti, Nb, V, and Ta can be appropriately added because it forms fine carbonitrides and improves punch fatigue strength by enhancing the steel sheet strength through precipitation strengthening. On the other hand, when the addition amount exceeds the above range, carbonitrides excessively form, and the iron losses deteriorate. Thus, the addition amounts of Ti, Nb, V, and Ta are in the ranges of Ti: 0% or more and 0.005% or less, Nb: 0% or more and 0.005% or less, V: 0% or more and 0.010% or less, and Ta: 0% or more and 0.002% or less, respectively. The upper limits of the addition amounts are preferably Ti: 0.002%, Nb: 0.002%, V: 0.005%, and Ta: 0.001%.

### B: 0% or More and 0.002% or Less, Ga: 0% or More and 0.005% or Less

B and Ga can be appropriately added because it forms fine nitrides and improves punch fatigue strength by enhancing the steel sheet strength through precipitation strengthening. On the other hand, when the addition amount exceeds the above range, nitrides excessively form, and the iron losses deteriorate. Thus, the addition amounts of B and Ga are in the ranges of B: 0% or more and 0.002% or less and Ga: 0% or more and 0.005% or less, respectively. The upper limits of the addition amounts are preferably B: 0.001% and Ga: 0.002%.

### Pb: 0% or More and 0.002% or Less

Pb can be appropriately added because it forms fine Pb grains and improves punch fatigue strength by enhancing the steel sheet strength through precipitation strengthening. On the other hand, when the addition amount exceeds the above range, Pb grains excessively form, and the iron losses deteriorate. Thus, the addition amount of Pb is in a range of 0% or more and 0.002% or less. The upper limit of the addition amount is preferably 0.001%.

### As: 0% or More and 0.05% or Less, Ge: 0% or More and 0.05% or Less

As and Ge are elements effective for improving the magnetic flux density and reducing iron losses by improving the texture, and can be appropriately added. However, when the addition amount exceeds 0.05%, the above effect reaches saturation. Thus, the upper limit of the addition amount is preferably 0.05% for each. More preferably, the addition amount is in a range of 0.002% or more and 0.01% or less for each.

### <Microstructure of Steel Sheet>

Next, the microstructure of the non-oriented electrical steel sheet according to aspects of the present invention will be described.

### <<Average Crystal Grain Size d is 60 μm or More and 200 μm or Less>>

According to the study by the inventors of the present invention, when the average crystal grain size d is coarse, the iron loss decreases. That is, the target iron loss characteristics can be achieved by setting the average crystal grain size d to 60 μm or more. On the other hand, when the average crystal grain size d is excessively coarse, the iron loss increases due to an increase in eddy current loss. That is, the target iron loss characteristics can be achieved by setting the average crystal grain size d to 200 μm or less.

<<Sum S_{A} of Area Ratios of Crystal Grains with <100> Oriented in Rolling Direction or Direction Perpendicular to Rolling Direction and Sum S_{B} of Area Ratios of Crystal Grains with <111> Oriented in Rolling Direction or Direction Perpendicular to the Rolling Direction Satisfy S_{A}−S_{B}≥0>>

According to the study by the inventors of the present invention, it has been found that, for steel having a predetermined component composition, a steel sheet structure in which the sum S_{A} of the area ratios of crystal grains with <100> oriented in the rolling direction or the direction perpendicular to the rolling direction and the sum S_{B} of the area ratios of crystal grains with <111> oriented in the rolling direction or the direction perpendicular to the rolling direction satisfy S_{A}−S_{B}≥0 is obtained, whereby the magnetic flux density of the steel sheet improves and the iron loss reduces. The allowable error of the crystal orientation was set to 15°. That is, when S_{A}−_{BD}≥0, the magnetic flux density and the iron loss satisfy the values required for the motors applied to HEV, EV, and FCEV, and thus S_{A}−S_{B}≥0 was satisfied. Preferably, S_{A}−S_{B}≥2% is satisfied, more preferably S_{A}−S_{B}≥5% is satisfied.

<<Sum S_{C} of Area Ratios of Crystal Grains with <100> Oriented in Rolling 45° Direction and Rolling −45° Direction and Sum S_{D} of Area Ratios of Crystal Grains with <111> Oriented in Rolling 45° Direction and Rolling −45° Direction Satisfy 5× S_{C}−S_{D}≥0>>

According to the study by the inventors of the present invention, it has been found that, in addition to the steel sheet structure, the steel sheet structure in which the sum Sc of the area ratios of the crystal grains with <100> oriented in a rolling 45° direction and a rolling −45° direction and the sum S_{D} of the area ratios of the crystal grains with <111> oriented in the rolling 45° direction and the rolling −45° direction satisfy 5 'S_{C}−S_{D}≥0 reduces the anisotropy of the magnetic properties. Reduction of anisotropy contributes to improvement of motor efficiency, and thus is more preferable as a material for a motor applied to HEV, EV, and FCEV. Thus, it is preferable to satisfy 5×S_{C}>S_{D}. More preferably, it satisfies 5×S_{C}>S_{D}≥1%.

Next, a method for manufacturing a non-oriented electrical steel sheet according to aspects of the present invention will be described.

Briefly speaking, the method for manufacturing a non-oriented electrical steel sheet according to aspects of the present invention is a method for obtaining the non-oriented electrical steel sheet according to aspects of the present invention described above by sequentially subjecting a steel material having the component composition described above to hot rolling, and hot-rolled sheet annealing, pickling, cold rolling, and annealing as necessary. In the method for manufacturing a non-oriented electrical steel sheet according to aspects of the present invention, other commonly known methods may be used as long as the components, cold rolling, and annealing conditions defined in accordance with aspects of the present invention are within the scope of the present invention.

### <Steel Material>

The steel material is not particularly limited as long as it is a steel material having the composition described above. The method for smelting the steel material is not particularly limited, and a known smelting method using a converter, an electric furnace, or the like can be adopted. From the viewpoint of productivity and the like, it is preferable to form a slab (steel material) by a continuous casting method after smelting, but the slab may be formed by a known casting method such as an agglomeration-ingot rolling method or a thin slab continuous casting method.

### <Hot Rolling Step>

The hot rolling step is a step of obtaining a hot-rolled sheet by subjecting a steel material having the composition described above to hot rolling. The hot rolling step is not particularly limited as long as it is a step in which a steel material having the composition described above is heated and hot-rolled to obtain a hot-rolled sheet having a predetermined dimension, and a normal hot rolling step can be applied.

Examples of the normal hot rolling step include a hot rolling step of heating a steel material to a temperature of 1000° C. or higher and 1200° C. or lower, subjecting the heated steel material to hot rolling at a finish-rolling-outlet-side temperature of 800° C. or higher and 950° C. or lower, and after completion of the hot rolling, subjecting the steel material to appropriate post-rolling cooling (for example, a temperature range of 450° C. or higher and 950° C. or lower is cooled at an average cooling rate of 20° C./s or more and 100° C./s or less), and winding the steel material at a winding temperature of 400° C. or higher and 700° C. or lower to form a hot rolled sheet having a predetermined dimension.

### <Hot-Rolled Sheet Annealing Step>

The hot-rolled sheet annealing step is a step of calcining the hot-rolled sheet by heating and holding the hot-rolled sheet at a high temperature. The hot-rolled sheet annealing step is not particularly limited, and a normal hot-rolled sheet annealing step can be applied. This step is not essential and can be omitted.

### <Pickling Step>

The pickling step is a step of performing pickling on the steel sheet after the hot-rolled sheet annealing step or the hot-rolled sheet when the hot-rolled sheet annealing step is omitted. The pickling step is not particularly limited as long as it is a step capable of performing pickling to such an extent that the steel sheet after pickling can be subjected to cold rolling, and for example, a normal pickling step using hydrochloric acid, sulfuric acid, or the like can be applied. This pickling step may be performed continuously in the same line as the hot-rolled sheet annealing step, or may be performed in a different line.

### <Cold Rolling Step>

The cold rolling step is a step of performing cold rolling on the pickled sheet that has undergone the pickling step. The cold rolling step is not particularly limited as long as the steel sheet after pickling can be pressed down to a desired sheet thickness, and a normal cold rolling step can be applied. In addition, a cold-rolled sheet having a predetermined dimension may be formed by two or more times of cold rolling with intermediate annealing as necessary. The intermediate annealing condition in this case is not particularly limited, and a normal intermediate annealing step can be applied. Preferably, the cold rolling step is a cold rolling step of performing cold rolling under the conditions that the work roll diameter D of the final pass is 150 mm ϕ or more, the rolling reduction ratio r of the final pass is 15% or more, and the strain rate (ε′ₘ) of the final pass is 100 s⁻¹ or more and 1300 s⁻¹ or less to obtain a cold-rolled sheet.

### (Work Roll Diameter D of Final Pass)

In the manufacture of the non-oriented electrical steel sheet according to aspects of the present invention, the work roll diameter D of the final pass is 150 mm ϕ or more. The reason of the work roll diameter D of the final pass being 150 mmϕ or more is to satisfy 5×S_{C}−S_{D}≥0 and obtain a desired steel sheet structure. When the work roll diameter D of the final pass is smaller than 150 mmϕ, the work roll diameter D is far away from the state of plane compression, and thus the nonuniformity of the shear strain in units of crystal grains is enhanced as compared with the case where the work roll diameter is large. Since nucleation and grain growth in the subsequent annealing step tend to concentrate in a region of a specific orientation, the sum S_{C} of the area ratios of the crystal grains with <100> oriented in rolling 45° and −45° directions decreases, and the sum S_{C} of the area ratios of the crystal grains with <111> oriented in the same direction increases. As a result, 5×S_{C}−S_{D}≥0 cannot be satisfied. On the other hand, when the work roll diameter D of the final pass is 150 mm ϕ or more, 5×S_{C}−S_{D}≥0 is satisfied, and a desired steel sheet structure is obtained.

The work roll diameter D of the final pass is preferably 170 mm ϕ or more, and more preferably 200 mm ϕ or more. The upper limit is not particularly required to be set, but is preferably 700 mm ϕ because the rolling load increases when the roll diameter is excessively large.

### (Rolling Reduction Ratio r of Final Pass)

In the manufacture of the non-oriented electrical steel sheet according to aspects of the present invention, the rolling reduction ratio r of the final pass is preferably 15% or more. The reason of the rolling reduction ratio r of the final pass being 15% or more is to obtain the effect of a series of cold rolling control and easily obtain a desired steel sheet structure. When the rolling reduction ratio r of the final pass is less than 15%, the reduction ratio is too low, which makes it difficult to control the structure after annealing. On the other hand, when the rolling reduction ratio r of the final pass is 15% or more, the effect of a series of cold rolling control is exhibited. As a result, a desired steel sheet structure tends to be obtained. The rolling reduction ratio r of the final pass is preferably 20% or more. In accordance with aspects of the present invention, it is not necessary to define the upper limit of the rolling reduction ratio r of the final pass, but the rolling reduction ratio that is too high requires a large device capacity, and it is difficult to control the shape of the cold-rolled sheet. Thus, the rolling reduction ratio r is usually 50% or less.

### (Strain Rate (ε′ₘ) in Final Pass)

In the manufacture of the non-oriented electrical steel sheet according to aspects of the present invention, the strain rate (ε′ₘ) in the final pass is preferably 100 s⁻¹ or more and 1300 s⁻¹ or less. The reason of the strain rate (ε′ₘ) in the final pass being set to 100 s⁻¹ or more and 1300 s⁻¹ or less is to obtain a desired steel sheet structure by setting 5×S_{C}−S_{D}≥0 while suppressing fracture during rolling. When the strain rate (ε′ₘ) in the final pass is less than 100 s⁻¹, the nonuniformity of the shear strain in the crystal grain unit of the cold-rolled sheet is enhanced, nucleation and grain growth in the subsequent annealing step are likely to concentrate in a region of a specific orientation, and thus, the sum S_{C} of the area ratios of the crystal grains with <100> oriented in rolling 45° and −45° directions decreases, and the sum S_{D} of the area ratios of the crystal grains with <111> oriented in the same direction increases. As a result, 5×S_{C}−S_{D}≥0 cannot be satisfied. The reason is not necessarily clear, but the inventors of the present invention presume that the flow stress is reduced due to the low strain rate, the strain tends to concentrate on the crystal grains of the crystal orientation that is easily deformed, and the strain distribution becomes non-uniform. On the other hand, when the strain rate in the final pass is more than 1300 s⁻¹, the flow stress is excessively increased, and brittle fracture during rolling is likely to occur. When the strain rate (ε′ₘ) in the final pass is 100 s⁻¹ or more and 1300 s⁻¹ or less, 5×S_{C}−S_{D}≥0 is satisfied while fracture during rolling is suppressed. The strain rate (ε′ₘ) in the final pass is preferably 150 s⁻¹ or more and preferably 1300 s⁻¹ or less. The strain rate (ε′ₘ) in each pass at the time of cold rolling in accordance with aspects of the present invention was derived using an approximate expression of Ekelund shown in the following Expression (1).

$${ε}_{m}^{′} \approx \frac{{v}_{R}}{\sqrt{{R}^{′} {h}_{1}}} \frac{2}{2 - r} \cdot \sqrt{r} \qquad ( 1 )$$

Here, v_{R} is a roll peripheral speed (mm/s), R′ is a roll radius (mm), h1 is a roll entrance sheet thickness (mm), and r is a rolling reduction ratio (%).

### <Annealing Step>

The annealing step is a step of performing annealing on the cold-rolled sheet subjected to the cold rolling step. More specifically, the annealing step is an annealing step of heating a cold-rolled sheet that has undergone the cold rolling step to an annealing temperature T₂ of 875° C. or higher and 1050° C. or lower under the conditions of an average temperature rising rate V₁ from 200° C. to a holding temperature T₁ of 400° C. or higher and 600° C. or lower of 50° C./s or more, a holding time at the holding temperature T₁ of 1 second or more and 10 seconds or less, and an average temperature rising rate V₂ from the holding temperature T₁ to 750° C. of 15° C./s or more, and then cooling the sheet to obtain a cold-rolled and annealed sheet. The surface of the cold-rolled and annealed sheet is subjected to an insulating coating after the annealing step, but this method and the type of coating are not particularly limited, and a normal insulating coating step can be applied.

### (Holding Temperature T₁)

In the manufacture of the non-oriented electrical steel sheet according to aspects of the present invention, the holding temperature T₁ during heating is set to 400° C. or higher and 600° C. or lower. The reason of the holding temperature T₁ being set to 400° C. or higher and 600° C. or lower is that the sum S_{A} of the area ratios of the crystal grains with <100> oriented in the rolling direction or the direction perpendicular to rolling and the sum S_{B} of the area ratios of the crystal grains with <111> oriented in the rolling direction or the direction perpendicular to rolling satisfy S_{A}-S_{B}≥0, and a desired steel sheet structure is obtained. When the holding temperature T₁ is lower than 400° C., since the temperature is too low, the holding effect cannot be obtained and S_{B} becomes high, and as a result, S_{A}−S_{B}≥0 cannot be satisfied. On the other hand, when the holding temperature T₁ is 600° C. or higher, not only the sum S_{B} of the area ratios but also the sum S_{A} of the area ratios decrease, and as a result, S_{A}−S_{B}≥0 cannot be satisfied.

(Average Temperature Rising Rate V₁ from 200° C. to Holding Temperature T₁)

In the manufacture of the non-oriented electrical steel sheet according to aspects of the present invention, the average temperature rising rate V₁ from 200° C. to the holding temperature T₁ is set to 50° C./s or more. The reason of the average temperature rising rate V₁ being set to 50° C./s or more is that the sum S_{A} of the area ratios of the crystal grains with <100> oriented in the rolling direction or the direction perpendicular to the rolling direction and the sum S_{B} of the area ratios of the crystal grains with <111> oriented in the rolling direction or the direction perpendicular to the rolling direction satisfy S_{A}−S_{B}≥0, and a desired steel sheet structure is obtained. When the average temperature rising rate V₁ is less than the above rate, recovery occurs before the holding at the holding temperature T₁, and thus the recovery behavior cannot be sufficiently controlled, and both S_{B} and S_{A} decrease, and as a result, S_{A}−S_{B}≥0 cannot be satisfied. The average temperature rising rate V₁ from 200° C. to the holding temperature T₁ is preferably 70° C./s or more, and more preferably 100° C./s or more. The upper limit is not particularly required to be set, but it is preferable to set the upper limit to 500° C./s because temperature unevenness is likely to occur when the temperature rising rate is excessively high.

### (Holding Time t at Holding Temperature T₁)

In the manufacture of the non-oriented electrical steel sheet according to aspects of the present invention, the holding time t at the holding temperature T₁ is 1 second or more and 10 seconds or less. The reason of the holding time t being set to 1 second or more and 10 seconds or less is that the sum S_{A} of the area ratios of the crystal grains with <100> oriented in the rolling direction or the direction perpendicular to the rolling direction and the sum S_{B} of the area ratios of the crystal grains with <111> oriented in the rolling direction or the direction perpendicular to the rolling direction satisfy S_{A}−S_{B}≥0, and a desired steel sheet structure is obtained. When the holding time t is less than 1 second, since tissue recovery does not sufficiently occur, S_{B} becomes high, and as a result, S_{A}−S_{B}≥0 cannot be satisfied. On the other hand, when the holding time t exceeds 10 seconds, tissue recovery occurs excessively, and not only S_{B} but also S_{A} decreases, and as a result, S_{A}−S_{B}≥0 cannot be satisfied.

### (Average Temperature Rising Rate V. From Holding Temperature T₁ to 750° C.)

In the manufacture of the non-oriented electrical steel sheet according to aspects of the present invention, the average temperature rising rate V₂ from the holding temperature T₁ to 750° C. is set to 15° C./s or more. The reason of the average temperature rising rate V₂ being set to 15° C./s or more is that the sum S_{A} of the area ratios of the crystal grains with <100> oriented in the rolling direction or the direction perpendicular to the rolling direction and the sum S_{B} of the area ratios of the crystal grains with <111> oriented in the rolling direction or the direction perpendicular to the rolling direction satisfy S_{A}−S_{B}≥0, and a desired steel sheet structure is obtained. When the average temperature rising rate V₂ is less than 15° C./s, the selectivity of the position where the recrystallization nucleus is generated is enhanced, and the frequency of generation of the crystal grains with <111> oriented in the rolling direction or the direction perpendicular to the rolling direction increases, and thus S_{B} increases. As a result, S_{A}−S_{B}≥0 cannot be satisfied. The average temperature rising rate V₂ is preferably 20° C./s or more, and more preferably 30° C./s or more. The upper limit is not particularly required to be set, but it is preferable to set the upper limit to 200° C./s because temperature unevenness is likely to occur when the temperature rising rate is excessively high.

### (Annealing Temperature T₂)

In the manufacture of the non-oriented electrical steel sheet according to aspects of the present invention, the annealing temperature T₂ is set to 875° C. or higher and 1050° C. or lower. The reason of the annealing temperature T₂ being set to 875° C. or higher and 1050° C. or lower is to obtain a desired steel sheet structure by setting the average crystal grain size to 60 μm or more. When the annealing temperature T₂ is lower than 875° C., recrystallized grains do not sufficiently grow, and the average crystal grain size cannot be 60 μm or more. When the annealing temperature T₂ is 875° C. or higher, sufficient grain growth occurs, and the average crystal grain size can be set to 60 μm or more. The annealing temperature T₂ is preferably 900° C. or higher. On the other hand, when the annealing temperature T₂ is higher than 1050° C., recrystallized grains excessively grow, and the average crystal grain size cannot be 200 μm or less. Thus, the annealing temperature T₂ is set to 1050° C. or lower. The temperature is preferably 1025° C. or lower. After heating to the annealing temperature, cooling is performed, and the cooling is preferably performed at a rate of 50° C./s or less from the viewpoint of preventing cooling unevenness.

### EXAMPLES

Hereinafter, aspects of the present invention will be specifically described with reference to Examples. However, the present invention is not limited to Examples.

### <Manufacture of Cold-Rolled and Annealed Sheet>

Molten steels having component compositions shown in Tables 1-1 and 2 were each melted by a generally known method and continuously cast to form a slab (steel material) having a thickness of 230 mm. The obtained slab was subjected to hot rolling to obtain a hot-rolled sheet having a sheet thickness of 2.0 mm. The obtained hot-rolled sheet was subjected to hot-rolled sheet annealing and pickling by a known method, and then subjected to cold rolling to a sheet thickness shown in Tables 2-1 and 2 to obtain a cold-rolled sheet. The obtained cold-rolled sheet was annealed under the conditions shown in Tables 2-1 and 2, and then coated by a known method to obtain a cold-rolled and annealed sheet (non-oriented electrical steel sheet).

TABLE 1-1

| Steel | Component composition [mass %] | | | | | | | | | | | | | | | | |
|---|---|---|---|---|---|---|---|---|---|---|---|---|---|---|---|---|---|
| type | C | Si | Mn | P | S | Al | N | Co | Zn | Mo | Cr | Ca | Mg | REM | Sn | Sb | Note |
| A | 0.0016 | 3.5 | 0.3 | 0.004 | 0.0029 | 0.6 | 0.0022 | — | — | — | — | — | — | — | — | — | Compatible |
| | | | | | | | | | | | | | | | | | Example |
| B | 0.0038 | 2.4 | 1.2 | 0.011 | 0.0033 | 1.2 | 0.0021 | — | — | — | — | — | — | — | — | — | Compatible |
| | | | | | | | | | | | | | | | | | Example |
| C | 0.0035 | 3.5 | 0.2 | 0.019 | 0.0017 | 1.1 | 0.0015 | — | — | — | — | — | — | — | — | — | Compatible |
| | | | | | | | | | | | | | | | | | Example |
| D | 0.0034 | 2.1 | 1.3 | 0.015 | 0.0027 | 0.9 | 0.0024 | — | — | — | — | — | — | — | — | — | Compatible |
| | | | | | | | | | | | | | | | | | Example |
| E | 0.0033 | 2.2 | 0.6 | 0.005 | 0.0033 | 1.8 | 0.0026 | — | — | — | — | — | — | — | — | — | Compatible |
| | | | | | | | | | | | | | | | | | Example |
| F | 0.0038 | 2.7 | 2.7 | 0.008 | 0.0021 | 0.5 | 0.0020 | — | — | — | — | — | — | — | — | — | Compatible |
| | | | | | | | | | | | | | | | | | Example |
| G | 0.0027 | 2.9 | 1.2 | 0.006 | 0.0031 | 1.9 | 0.0024 | — | — | — | — | — | — | — | — | — | Compatible |
| | | | | | | | | | | | | | | | | | Example |
| H | 0.0009 | 2.3 | 1.2 | 0.011 | 0.0024 | 1.4 | 0.0025 | — | — | — | — | — | — | — | — | — | Compatible |
| | | | | | | | | | | | | | | | | | Example |
| I | 0.0029 | 2.9 | 1.0 | 0.012 | 0.0037 | 1.2 | 0.0027 | — | — | — | — | — | — | — | — | — | Compatible |
| | | | | | | | | | | | | | | | | | Example |
| J | 0.0015 | 3.9 | 0.7 | 0.013 | 0.0008 | 1.5 | 0.0023 | — | — | — | — | — | — | — | — | — | Compatible |
| | | | | | | | | | | | | | | | | | Example |
| K | 0.0047 | 2.2 | 1.3 | 0.009 | 0.0021 | 1.3 | 0.0024 | — | — | — | — | — | — | — | — | — | Compatible |
| | | | | | | | | | | | | | | | | | Example |
| L | 0.0017 | 0.8 | 0.8 | 0.013 | 0.0007 | 1.5 | 0.0021 | — | — | — | — | — | — | — | — | — | Comparative |
| | | | | | | | | | | | | | | | | | Example |
| M | 0.0016 | 1.2 | 0.8 | 0.012 | 0.0009 | 1.5 | 0.0022 | — | — | — | — | — | — | — | — | — | Compatible |
| | | | | | | | | | | | | | | | | | Example |
| N | 0.0013 | 1.5 | 0.7 | 0.011 | 0.0009 | 1.6 | 0.0022 | — | — | — | — | — | — | — | — | — | Compatible |
| | | | | | | | | | | | | | | | | | Example |
| O | 0.0015 | 4.8 | 0.7 | 0.015 | 0.0005 | 1.5 | 0.0022 | — | — | — | — | — | — | — | — | — | Compatible |
| | | | | | | | | | | | | | | | | | Example |
| P | 0.0017 | 5.2 | 0.7 | 0.014 | 0.0005 | 1.4 | 0.0024 | — | — | — | — | — | — | — | — | — | Comparative |
| | | | | | | | | | | | | | | | | | Example |
| Q | 0.0035 | 2.1 | 0.02 | 0.017 | 0.0028 | 0.9 | 0.0023 | — | — | — | — | — | — | — | — | — | Comparative |
| | | | | | | | | | | | | | | | | | Example |
| R | 0.0036 | 2.1 | 0.08 | 0.013 | 0.0023 | 0.8 | 0.0026 | — | — | — | — | — | — | — | — | — | Compatible |
| | | | | | | | | | | | | | | | | | Example |
| S | 0.0035 | 2.0 | 3.4 | 0.013 | 0.0030 | 0.8 | 0.0026 | — | — | — | — | — | — | — | — | — | Compatible |
| | | | | | | | | | | | | | | | | | Example |
| T | 0.0034 | 2.1 | 5.1 | 0.015 | 0.0023 | 1.0 | 0.0022 | — | — | — | — | — | — | — | — | — | Comparative |
| | | | | | | | | | | | | | | | | | Example |
| U | 0.0031 | 3.0 | 1.0 | 0.011 | 0.0033 | 0.003 | 0.0028 | — | — | — | — | — | — | — | — | — | Comparative |
| | | | | | | | | | | | | | | | | | Example |
| V | 0.0029 | 3.0 | 1.0 | 0.010 | 0.0038 | 0.012 | 0.0028 | — | — | — | — | — | — | — | — | — | Compatible |
| | | | | | | | | | | | | | | | | | Example |
| W | 0.0028 | 2.8 | 1.0 | 0.014 | 0.0038 | 2.2 | 0.0027 | — | — | — | — | — | — | — | — | — | Compatible |
| | | | | | | | | | | | | | | | | | Example |
| X | 0.0030 | 2.9 | 1.1 | 0.012 | 0.0039 | 3.4 | 0.0028 | — | — | — | — | — | — | — | — | — | Comparative |
| | | | | | | | | | | | | | | | | | Example |
| Y | 0.0035 | 3.4 | 0.3 | 0.020 | 0.0018 | 1.1 | 0.0013 | 0.0007 | — | — | — | — | — | — | — | — | Compatible |
| | | | | | | | | | | | | | | | | | Example |
| Z | 0.0037 | 3.5 | 0.2 | 0.017 | 0.0014 | 1.1 | 0.0016 | 0.0038 | — | — | — | — | — | — | — | — | Compatible |
| | | | | | | | | | | | | | | | | | Example |
| AA | 0.0037 | 3.4 | 0.2 | 0.018 | 0.0020 | 1.0 | 0.0014 | — | 0.0008 | — | — | — | — | — | — | — | Compatible |
| | | | | | | | | | | | | | | | | | Example |
| AB | 0.0033 | 3.6 | 0.2 | 0.019 | 0.0016 | 1.1 | 0.0013 | — | 0.0029 | — | — | — | — | — | — | — | Compatible |
| | | | | | | | | | | | | | | | | | Example |
| AC | 0.0016 | 3.5 | 0.3 | 0.003 | 0.0031 | 0.6 | 0.0023 | — | — | 0.035 | — | — | — | — | — | — | Compatible |
| | | | | | | | | | | | | | | | | | Example |
| AD | 0.0015 | 3.5 | 0.3 | 0.005 | 0.0028 | 0.6 | 0.0023 | — | — | — | 0.14 | — | — | — | — | — | Compatible |
| | | | | | | | | | | | | | | | | | Example |
| AE | 0.0017 | 3.6 | 0.4 | 0.005 | 0.0024 | 0.5 | 0.0023 | — | — | — | — | 0.004 | — | — | — | — | Compatible |
| | | | | | | | | | | | | | | | | | Example |
| AF | 0.0014 | 3.5 | 0.2 | 0.003 | 0.0030 | 0.6 | 0.0020 | — | — | — | — | — | 0.003 | — | — | — | Compatible |
| | | | | | | | | | | | | | | | | | Example |
| AG | 0.0018 | 3.5 | 0.3 | 0.002 | 0.0029 | 0.6 | 0.0023 | — | — | — | — | — | — | 0.005 | — | — | Compatible |
| | | | | | | | | | | | | | | | | | Example |
| AH | 0.0017 | 3.5 | 0.4 | 0.006 | 0.0031 | 0.7 | 0.0022 | — | — | — | — | — | — | — | 0.032 | — | Compatible |
| | | | | | | | | | | | | | | | | | Example |
| AI | 0.0016 | 3.5 | 0.3 | 0.003 | 0.0033 | 0.6 | 0.0024 | — | — | — | — | — | — | — | — | 0.054 | Compatible |
| | | | | | | | | | | | | | | | | | Example |

TABLE 1-2

| Steel | Component composition [mass %] | | | | | | | | | | | | | | | |
|---|---|---|---|---|---|---|---|---|---|---|---|---|---|---|---|---|
| type | C | Si | Mn | P | S | Al | N | Co | Zn | Mo | Cr | Ca | Mg | REM | Sn | Sb |
| AJ | 0.0034 | 3.4 | 0.3 | 0.021 | 0.0013 | 1.0 | 0.0013 | 0.0021 | — | — | — | — | — | — | — | — |
| AK | 0.0037 | 3.4 | 0.2 | 0.017 | 0.0021 | 1.0 | 0.0017 | — | 0.0046 | — | — | — | — | — | — | — |
| AL | 0.0014 | 3.4 | 0.4 | 0.003 | 0.0031 | 0.6 | 0.0023 | — | — | 0.013 | — | — | — | — | — | — |
| AM | 0.0015 | 3.5 | 0.4 | 0.004 | 0.0030 | 0.6 | 0.0021 | — | — | — | 4.3 | — | — | — | — | — |
| AN | 0.0017 | 3.5 | 0.2 | 0.005 | 0.0030 | 0.6 | 0.0023 | — | — | — | — | 0.001 | — | — | — | — |
| AO | 0.0016 | 3.5 | 0.3 | 0.003 | 0.0032 | 0.5 | 0.0022 | — | — | — | — | — | 0.096 | — | — | — |
| AP | 0.0015 | 3.5 | 0.3 | 0.003 | 0.0032 | 0.6 | 0.0023 | — | — | — | — | — | — | 0.093 | — | — |
| AQ | 0.0015 | 3.5 | 0.3 | 0.003 | 0.0026 | 0.7 | 0.0020 | — | — | — | — | — | — | — | 0.17 | — |
| AR | 0.0018 | 3.6 | 0.3 | 0.005 | 0.0033 | 0.7 | 0.0024 | — | — | — | — | — | — | — | — | 0.18 |
| AS | 0.0040 | 2.3 | 1.2 | 0.011 | 0.0031 | 1.2 | 0.0019 | — | — | — | — | — | — | — | — | — |
| AT | 0.0038 | 2.5 | 1.2 | 0.011 | 0.0036 | 1.3 | 0.0021 | — | — | — | — | — | — | — | — | — |
| AU | 0.0037 | 2.5 | 1.2 | 0.012 | 0.0037 | 1.2 | 0.0023 | — | — | — | — | — | — | — | — | — |
| AV | 0.0037 | 2.5 | 1.1 | 0.013 | 0.0030 | 1.2 | 0.0022 | — | — | — | — | — | — | — | — | — |
| AW | 0.0032 | 2.3 | 0.5 | 0.003 | 0.0030 | 1.8 | 0.0026 | — | — | — | — | — | — | — | — | — |
| AX | 0.0034 | 2.2 | 0.7 | 0.006 | 0.0029 | 1.8 | 0.0024 | — | — | — | — | — | — | — | — | — |
| AY | 0.0035 | 2.1 | 0.5 | 0.005 | 0.0036 | 1.8 | 0.0028 | — | — | — | — | — | — | — | — | — |
| AZ | 0.0032 | 2.1 | 0.5 | 0.005 | 0.0033 | 1.9 | 0.0025 | — | — | — | — | — | — | — | — | — |
| BA | 0.0031 | 2.2 | 0.5 | 0.003 | 0.0029 | 1.8 | 0.0026 | — | — | — | — | — | — | — | — | — |
| BB | 0.0032 | 2.2 | 0.5 | 0.005 | 0.0029 | 1.7 | 0.0025 | — | — | — | — | — | — | — | — | — |
| BC | 0.0032 | 2.3 | 0.5 | 0.003 | 0.0032 | 1.7 | 0.0028 | — | — | — | — | — | — | — | — | — |
| BD | 0.0032 | 2.2 | 0.5 | 0.007 | 0.0038 | 1.9 | 0.0024 | — | — | — | — | — | — | — | — | — |
| BE | 0.0034 | 2.2 | 0.6 | 0.003 | 0.0031 | 1.8 | 0.0025 | — | — | — | — | — | — | — | — | — |
| BF | 0.0032 | 2.1 | 0.7 | 0.005 | 0.0030 | 1.8 | 0.0025 | — | — | — | — | — | — | — | — | — |
| BG | 0.0039 | 2.7 | 2.7 | 0.007 | 0.0024 | 0.5 | 0.0020 | — | — | — | — | — | — | — | — | — |
| BH | 0.0038 | 2.7 | 2.6 | 0.006 | 0.0016 | 0.5 | 0.0020 | — | — | — | — | — | — | — | — | — |
| BI | 0.0039 | 2.7 | 2.7 | 0.010 | 0.0020 | 0.5 | 0.0022 | — | — | — | — | — | — | — | — | — |
| BJ | 0.0039 | 2.6 | 2.6 | 0.008 | 0.0022 | 0.5 | 0.0022 | — | — | — | — | — | — | — | — | — |
| BK | 0.0040 | 2.7 | 2.6 | 0.010 | 0.0022 | 0.4 | 0.0022 | — | — | — | — | — | — | — | — | — |
| BL | 0.0040 | 2.6 | 2.6 | 0.007 | 0.0020 | 0.5 | 0.0020 | — | — | — | — | — | — | — | — | — |
| BM | 0.0028 | 2.9 | 1.1 | 0.004 | 0.0026 | 2.0 | 0.0023 | — | — | — | — | — | — | — | — | — |
| BN | 0.0028 | 2.9 | 1.1 | 0.004 | 0.0031 | 1.9 | 0.0024 | — | — | — | — | — | — | — | — | — |
| BO | 0.0029 | 2.9 | 1.1 | 0.004 | 0.0036 | 1.9 | 0.0025 | — | — | — | — | — | — | — | — | — |
| BP | 0.0030 | 3.0 | 1.3 | 0.009 | 0.0036 | 2.0 | 0.0027 | — | — | — | — | — | — | — | — | — |

| Steel | Component composition [mass %] | | | | | | | | | | | | |
|---|---|---|---|---|---|---|---|---|---|---|---|---|---|
| type | Cu | Ni | W | Ti | Nb | V | Ta | B | Ga | Pb | As | Ge | Note |
| AJ | — | — | — | — | — | — | — | — | — | — | — | — | Compatible |
| | | | | | | | | | | | | | Example |
| AK | — | — | — | — | — | — | — | — | — | — | — | — | Compatible |
| | | | | | | | | | | | | | Example |
| AL | — | — | — | — | — | — | — | — | — | — | — | — | Compatible |
| | | | | | | | | | | | | | Example |
| AM | — | — | — | — | — | — | — | — | — | — | — | — | Compatible |
| | | | | | | | | | | | | | Example |
| AN | — | — | — | — | — | — | — | — | — | — | — | — | Compatible |
| | | | | | | | | | | | | | Example |
| AO | — | — | — | — | — | — | — | — | — | — | — | — | Compatible |
| | | | | | | | | | | | | | Example |
| AP | — | — | — | — | — | — | — | — | — | — | — | — | Compatible |
| | | | | | | | | | | | | | Example |
| AQ | — | — | — | — | — | — | — | — | — | — | — | — | Compatible |
| | | | | | | | | | | | | | Example |
| AR | — | — | — | — | — | — | — | — | — | — | — | — | Compatible |
| | | | | | | | | | | | | | Example |
| AS | 0.03 | — | — | — | — | — | — | — | — | — | — | — | Compatible |
| | | | | | | | | | | | | | Example |
| AT | 0.49 | — | — | — | — | — | — | — | — | — | — | — | Compatible |
| | | | | | | | | | | | | | Example |
| AU | — | 0.02 | — | — | — | — | — | — | — | — | — | — | Compatible |
| | | | | | | | | | | | | | Example |
| AV | — | 0.46 | — | — | — | — | — | — | — | — | — | — | Compatible |
| | | | | | | | | | | | | | Example |
| AW | — | — | 0.006 | — | — | — | — | — | — | — | — | — | Compatible |
| | | | | | | | | | | | | | Example |
| AX | — | — | 0.043 | — | — | — | — | — | — | — | — | — | Compatible |
| | | | | | | | | | | | | | Example |
| AY | — | — | — | 0.0016 | — | — | — | — | — | — | — | — | Compatible |
| | | | | | | | | | | | | | Example |
| AZ | — | — | — | 0.0047 | — | — | — | — | — | — | — | — | Compatible |
| | | | | | | | | | | | | | Example |
| BA | — | — | — | — | 0.0007 | — | — | — | — | — | — | — | Compatible |
| | | | | | | | | | | | | | Example |
| BB | — | — | — | — | 0.0045 | — | — | — | — | — | — | — | Compatible |
| | | | | | | | | | | | | | Example |
| BC | — | — | — | — | — | 0.0011 | — | — | — | — | — | — | Compatible |
| | | | | | | | | | | | | | Example |
| BD | — | — | — | — | — | 0.0095 | — | — | — | — | — | — | Compatible |
| | | | | | | | | | | | | | Example |
| BE | — | — | — | — | — | — | 0.0004 | — | — | — | — | — | Compatible |
| | | | | | | | | | | | | | Example |
| BF | — | — | — | — | — | — | 0.0017 | — | — | — | — | — | Compatible |
| | | | | | | | | | | | | | Example |
| BG | — | — | — | — | — | — | — | 0.0002 | — | — | — | — | Compatible |
| | | | | | | | | | | | | | Example |
| BH | — | — | — | — | — | — | — | 0.0018 | — | — | — | — | Compatible |
| | | | | | | | | | | | | | Example |
| BI | — | — | — | — | — | — | — | — | 0.0002 | — | — | — | Compatible |
| | | | | | | | | | | | | | Example |
| BJ | — | — | — | — | — | — | — | — | 0.0047 | — | — | — | Compatible |
| | | | | | | | | | | | | | Example |
| BK | — | — | — | — | — | — | — | — | — | 0.0002 | — | — | Compatible |
| | | | | | | | | | | | | | Example |
| BL | — | — | — | — | — | — | — | — | — | 0.0019 | — | — | Compatible |
| | | | | | | | | | | | | | Example |
| BM | — | — | — | — | — | — | — | — | — | — | 0.004 | — | Compatible |
| | | | | | | | | | | | | | Example |
| BN | — | — | — | — | — | — | — | — | — | — | 0.043 | — | Compatible |
| | | | | | | | | | | | | | Example |
| BO | — | — | — | — | — | — | — | — | — | — | — | 0.002 | Compatible |
| | | | | | | | | | | | | | Example |
| BP | — | — | — | — | — | — | — | — | — | — | — | 0.046 | Compatible |
| | | | | | | | | | | | | | Example |

TABLE 2-1

| | | | Cold rolling step | | | | Annealing step | | | | | |
|---|---|---|---|---|---|---|---|---|---|---|---|---|
| | | | Work roll | Rolling | strain | | | Temper- | | Temper- | | |
| | | | diameter | reduction | rate in | | Holding | ature | | ature | Annealing | |
| | | Sheet | D of | ratio r of | final | Fracture | temper- | rising | Holding | rising | temper- | |
| | Steel | thickness | final pass | final pass | pass | during | ature T₁ | rate V₁ | time t | rate V₂ | ature T₂ | |
| No. | type | [mm] | [mmϕ] | [%] | [s⁻¹] | rolling | [° C.] | [° C./s] | [s] | [° C./s] | [° C.] | Note |
| 1 | A | 0.25 | 290 | 28 | 780 | — | 490 | 270 | 2 | 34 | 1000 | Invention |
| | | | | | | | | | | | | Example |
| 2 | B | 0.25 | 330 | 23 | 860 | — | 480 | 460 | 3 | 53 | 990 | Invention |
| | | | | | | | | | | | | Example |
| 3 | C | 0.25 | 360 | 31 | 300 | — | 590 | 120 | 9 | 33 | 920 | Invention |
| | | | | | | | | | | | | Example |
| 4 | D | 0.25 | 390 | 27 | 260 | — | 470 | 120 | 7 | 31 | 1010 | Invention |
| | | | | | | | | | | | | Example |
| 5 | E | 0.25 | 360 | 23 | 200 | — | 420 | 480 | 2 | 55 | 940 | Invention |
| | | | | | | | | | | | | Example |
| 6 | F | 0.25 | 340 | 25 | 190 | — | 590 | 320 | 9 | 49 | 1000 | Invention |
| | | | | | | | | | | | | Example |
| 7 | G | 0.25 | 290 | 29 | 700 | — | 440 | 310 | 5 | 37 | 1010 | Invention |
| | | | | | | | | | | | | Example |
| 8 | H | 0.25 | 360 | 24 | 510 | — | 420 | 350 | 3 | 33 | 960 | Invention |
| | | | | | | | | | | | | Example |
| 9 | I | 0.25 | 200 | 33 | 690 | — | 500 | 380 | 3 | 54 | 990 | Invention |
| | | | | | | | | | | | | Example |
| 10 | J | 0.25 | 210 | 34 | 710 | — | 510 | 190 | 3 | 47 | 910 | Invention |
| | | | | | | | | | | | | Example |
| 11 | K | 0.25 | 360 | 24 | 510 | — | 420 | 340 | 3 | 34 | 960 | Invention |
| | | | | | | | | | | | | Example |
| 12 | L | 0.25 | 210 | 34 | 710 | — | 510 | 190 | 3 | 47 | 910 | Compar- |
| | | | | | | | | | | | | ative |
| | | | | | | | | | | | | Example |
| 13 | M | 0.25 | 210 | 34 | 710 | — | 510 | 200 | 3 | 47 | 910 | Invention |
| | | | | | | | | | | | | Example |
| 14 | N | 0.25 | 210 | 34 | 710 | — | 510 | 190 | 3 | 49 | 910 | Invention |
| | | | | | | | | | | | | Example |
| 15 | O | 0.25 | 210 | 34 | 710 | — | 510 | 180 | 3 | 49 | 910 | Invention |
| | | | | | | | | | | | | Example |
| 16 | P | 0.25 | 210 | 34 | 710 | — | 510 | 190 | 3 | 46 | 910 | Compar- |
| | | | | | | | | | | | | ative |
| | | | | | | | | | | | | Example |
| 17 | Q | 0.25 | 390 | 27 | 260 | — | 470 | 120 | 7 | 30 | 1010 | Compar- |
| | | | | | | | | | | | | ative |
| | | | | | | | | | | | | Example |
| 18 | R | 0.25 | 390 | 27 | 260 | — | 470 | 120 | 7 | 32 | 1010 | Invention |
| | | | | | | | | | | | | Example |
| 19 | S | 0.25 | 390 | 27 | 260 | — | 470 | 120 | 7 | 31 | 1010 | Invention |
| | | | | | | | | | | | | Example |
| 20 | T | 0.25 | 390 | 27 | 260 | — | 470 | 130 | 7 | 33 | 1010 | Compar- |
| | | | | | | | | | | | | ative |
| | | | | | | | | | | | | Example |
| 21 | U | 0.25 | 200 | 33 | 690 | — | 500 | 370 | 3 | 52 | 990 | Compar- |
| | | | | | | | | | | | | ative |
| | | | | | | | | | | | | Example |
| 22 | V | 0.25 | 200 | 33 | 690 | — | 500 | 400 | 3 | 56 | 990 | Invention |
| | | | | | | | | | | | | Example |
| 23 | W | 0.25 | 200 | 33 | 690 | — | 500 | 380 | 3 | 54 | 990 | Invention |
| | | | | | | | | | | | | Example |
| 24 | X | 0.25 | 200 | 33 | 690 | — | 500 | 360 | 3 | 55 | 990 | Compar- |
| | | | | | | | | | | | | ative |
| | | | | | | | | | | | | Example |
| 25 | Y | 0.25 | 360 | 31 | 300 | — | 590 | 130 | 9 | 32 | 920 | Invention |
| | | | | | | | | | | | | Example |
| 26 | Z | 0.25 | 360 | 31 | 300 | — | 590 | 120 | 9 | 32 | 920 | Invention |
| | | | | | | | | | | | | Example |
| 27 | AA | 0.25 | 360 | 31 | 300 | — | 590 | 120 | 9 | 33 | 920 | Invention |
| | | | | | | | | | | | | Example |
| 28 | AB | 0.25 | 360 | 31 | 300 | — | 590 | 120 | 9 | 31 | 920 | Invention |
| | | | | | | | | | | | | Example |
| 29 | AC | 0.25 | 290 | 28 | 780 | — | 490 | 260 | 2 | 33 | 1000 | Invention |
| | | | | | | | | | | | | Example |
| 30 | AD | 0.25 | 290 | 28 | 780 | — | 490 | 280 | 2 | 35 | 1000 | Invention |
| | | | | | | | | | | | | Example |
| 31 | AE | 0.25 | 290 | 28 | 780 | — | 490 | 270 | 2 | 34 | 1000 | Invention |
| | | | | | | | | | | | | Example |
| 32 | AF | 0.25 | 290 | 28 | 780 | — | 490 | 270 | 2 | 33 | 1000 | Invention |
| | | | | | | | | | | | | Example |
| 33 | AG | 0.25 | 290 | 28 | 780 | — | 490 | 270 | 2 | 35 | 1000 | Invention |
| | | | | | | | | | | | | Example |
| 34 | AH | 0.25 | 290 | 28 | 780 | — | 490 | 260 | 2 | 33 | 1000 | Invention |
| | | | | | | | | | | | | Example |
| 35 | AI | 0.25 | 290 | 28 | 780 | — | 490 | 270 | 2 | 34 | 1000 | Invention |
| | | | | | | | | | | | | Example |
| 36 | J | 0.25 | 210 | 34 | 710 | — | 630 | 190 | 3 | 46 | 910 | Compar- |
| | | | | | | | | | | | | ative |
| | | | | | | | | | | | | Example |
| 37 | J | 0.25 | 210 | 34 | 710 | — | 380 | 190 | 3 | 47 | 910 | Compar- |
| | | | | | | | | | | | | ative |
| | | | | | | | | | | | | Example |
| 38 | D | 0.25 | 390 | 27 | 260 | — | 470 | 30 | 7 | 31 | 1010 | Compar- |
| | | | | | | | | | | | | ative |
| | | | | | | | | | | | | Example |
| 39 | D | 0.25 | 390 | 27 | 260 | — | 470 | 60 | 7 | 31 | 1010 | Invention |
| | | | | | | | | | | | | Example |
| 40 | D | 0.25 | 390 | 27 | 260 | — | 470 | 90 | 7 | 32 | 1010 | Invention |
| | | | | | | | | | | | | Example |
| 41 | G | 0.25 | 290 | 29 | 700 | — | 440 | 300 | 0 | 37 | 1010 | Compar- |
| | | | | | | | | | | | | ative |
| | | | | | | | | | | | | Example |
| 42 | G | 0.25 | 290 | 29 | 700 | — | 440 | 300 | 15 | 38 | 1010 | Compar- |
| | | | | | | | | | | | | ative |
| | | | | | | | | | | | | Example |
| 43 | I | 0.25 | 200 | 33 | 690 | — | 500 | 380 | 3 | 8 | 990 | Compar- |
| | | | | | | | | | | | | ative |
| | | | | | | | | | | | | Example |
| 44 | I | 0.25 | 200 | 33 | 690 | — | 500 | 400 | 3 | 17 | 990 | Invention |
| | | | | | | | | | | | | Example |
| 45 | I | 0.25 | 200 | 33 | 690 | — | 500 | 380 | 3 | 24 | 990 | Invention |
| | | | | | | | | | | | | Example |
| 46 | C | 0.25 | 360 | 31 | 300 | — | 500 | 120 | 3 | 33 | 860 | Compar- |
| | | | | | | | | | | | | ative |
| | | | | | | | | | | | | Example |
| 47 | C | 0.25 | 360 | 31 | 300 | — | 590 | 120 | 9 | 33 | 880 | Invention |
| | | | | | | | | | | | | Example |
| 48 | C | 0.25 | 360 | 31 | 300 | — | 590 | 120 | 9 | 34 | 1040 | Invention |
| | | | | | | | | | | | | Example |
| 49 | C | 0.25 | 360 | 31 | 300 | — | 590 | 130 | 9 | 33 | 1070 | Compar- |
| | | | | | | | | | | | | ative |
| | | | | | | | | | | | | Example |
| 50 | A | 0.25 | 110 | 28 | 780 | — | 490 | 270 | 2 | 32 | 1000 | Invention |
| | | | | | | | | | | | | Example |
| 51 | A | 0.25 | 160 | 28 | 780 | — | 490 | 280 | 2 | 35 | 1000 | Invention |
| | | | | | | | | | | | | Example |
| 52 | A | 0.25 | 180 | 28 | 780 | — | 490 | 270 | 2 | 33 | 1000 | Invention |
| | | | | | | | | | | | | Example |
| 53 | A | 0.25 | 290 | 9 | 780 | — | 490 | 270 | 2 | 35 | 1000 | Invention |
| | | | | | | | | | | | | Example |
| 54 | A | 0.25 | 290 | 17 | 780 | — | 490 | 280 | 2 | 34 | 1000 | Invention |
| | | | | | | | | | | | | Example |
| 55 | A | 0.25 | 290 | 28 | 60 | — | 490 | 260 | 2 | 34 | 1000 | Invention |
| | | | | | | | | | | | | Example |
| 56 | A | 0.25 | 290 | 28 | 120 | — | 490 | 260 | 2 | 33 | 1000 | Invention |
| | | | | | | | | | | | | Example |
| 57 | A | 0.25 | 290 | 28 | 1400 | Partially | 490 | 260 | 2 | 34 | 1000 | Invention |
| | | | | | | fractured | | | | | | Example |

Note)
Underlined part is outside scope of the invention

TABLE 2-2

| | | | Cold rolling step | | | | Annealing step | | | | | |
|---|---|---|---|---|---|---|---|---|---|---|---|---|
| | | | Work roll | Rolling | strain | | | Temper- | | Temper- | | |
| | | Sheet | diameter | reduction | rate in | | Holding | ature | | ature | Annealing | |
| | | thick- | D of | ratio r of | final | Fracture | temper- | rising | Holding | rising | temper- | |
| | Steel | ness | final pass | final pass | pass | during | ature T₁ | rate V₁ | time t | rate V₂ | ature T₂ | |
| No. | type | [mm] | [mmϕ] | [%] | [s⁻¹] | rolling | [° C.] | [° C./s] | [s] | [° C./s] | [° C.] | Note |
| 58 | AJ | 0.25 | 360 | 31 | 300 | — | 590 | 120 | 9 | 31 | 920 | Invention |
| | | | | | | | | | | | | Example |
| 59 | AK | 0.25 | 360 | 31 | 300 | — | 590 | 120 | 9 | 32 | 920 | Invention |
| | | | | | | | | | | | | Example |
| 60 | AL | 0.25 | 290 | 28 | 780 | — | 490 | 270 | 2 | 33 | 1000 | Invention |
| | | | | | | | | | | | | Example |
| 61 | AM | 0.25 | 290 | 28 | 780 | — | 490 | 260 | 2 | 35 | 1000 | Invention |
| | | | | | | | | | | | | Example |
| 62 | AN | 0.25 | 290 | 28 | 780 | — | 490 | 260 | 2 | 34 | 1000 | Invention |
| | | | | | | | | | | | | Example |
| 63 | AO | 0.25 | 290 | 28 | 780 | — | 490 | 260 | 2 | 33 | 1000 | Invention |
| | | | | | | | | | | | | Example |
| 64 | AP | 0.25 | 290 | 28 | 780 | — | 490 | 280 | 2 | 35 | 1000 | Invention |
| | | | | | | | | | | | | Example |
| 65 | AQ | 0.25 | 290 | 28 | 780 | — | 490 | 280 | 2 | 33 | 1000 | Invention |
| | | | | | | | | | | | | Example |
| 66 | AR | 0.25 | 290 | 28 | 780 | — | 490 | 260 | 2 | 34 | 1000 | Invention |
| | | | | | | | | | | | | Example |
| 67 | AS | 0.25 | 330 | 23 | 860 | — | 480 | 470 | 3 | 53 | 990 | Invention |
| | | | | | | | | | | | | Example |
| 68 | AT | 0.25 | 330 | 23 | 860 | — | 480 | 460 | 3 | 52 | 990 | Invention |
| | | | | | | | | | | | | Example |
| 69 | AU | 0.25 | 330 | 23 | 860 | — | 480 | 480 | 3 | 53 | 990 | Invention |
| | | | | | | | | | | | | Example |
| 70 | AV | 0.25 | 330 | 23 | 860 | — | 480 | 450 | 3 | 54 | 990 | Invention |
| | | | | | | | | | | | | Example |
| 71 | AW | 0.25 | 360 | 23 | 200 | — | 420 | 480 | 2 | 57 | 940 | Invention |
| | | | | | | | | | | | | Example |
| 72 | AX | 0.25 | 360 | 23 | 200 | — | 420 | 480 | 2 | 57 | 940 | Invention |
| | | | | | | | | | | | | Example |
| 73 | AY | 0.25 | 360 | 23 | 200 | — | 420 | 470 | 2 | 57 | 940 | Invention |
| | | | | | | | | | | | | Example |
| 74 | AZ | 0.25 | 360 | 23 | 200 | — | 420 | 470 | 2 | 54 | 940 | Invention |
| | | | | | | | | | | | | Example |
| 75 | BA | 0.25 | 360 | 23 | 200 | — | 420 | 490 | 2 | 54 | 940 | Invention |
| | | | | | | | | | | | | Example |
| 76 | BB | 0.25 | 360 | 23 | 200 | — | 420 | 460 | 2 | 55 | 940 | Invention |
| | | | | | | | | | | | | Example |
| 77 | BC | 0.25 | 360 | 23 | 200 | — | 420 | 490 | 2 | 53 | 940 | Invention |
| | | | | | | | | | | | | Example |
| 78 | BD | 0.25 | 360 | 23 | 200 | — | 420 | 490 | 2 | 55 | 940 | Invention |
| | | | | | | | | | | | | Example |
| 79 | BE | 0.25 | 360 | 23 | 200 | — | 420 | 460 | 2 | 55 | 940 | Invention |
| | | | | | | | | | | | | Example |
| 80 | BF | 0.25 | 360 | 23 | 200 | — | 420 | 500 | 2 | 52 | 940 | Invention |
| | | | | | | | | | | | | Example |
| 81 | BG | 0.25 | 340 | 25 | 190 | — | 590 | 320 | 9 | 50 | 1000 | Invention |
| | | | | | | | | | | | | Example |
| 82 | BH | 0.25 | 340 | 25 | 190 | — | 590 | 330 | 9 | 50 | 1000 | Invention |
| | | | | | | | | | | | | Example |
| 83 | BI | 0.25 | 340 | 25 | 190 | — | 590 | 320 | 9 | 48 | 1000 | Invention |
| | | | | | | | | | | | | Example |
| 84 | BJ | 0.25 | 340 | 25 | 190 | — | 590 | 330 | 9 | 51 | 1000 | Invention |
| | | | | | | | | | | | | Example |
| 85 | BK | 0.25 | 340 | 25 | 190 | — | 590 | 330 | 9 | 48 | 1000 | Invention |
| | | | | | | | | | | | | Example |
| 86 | BL | 0.25 | 340 | 25 | 190 | — | 590 | 320 | 9 | 51 | 1000 | Invention |
| | | | | | | | | | | | | Example |
| 87 | BM | 0.25 | 290 | 29 | 700 | — | 440 | 320 | 5 | 36 | 1010 | Invention |
| | | | | | | | | | | | | Example |
| 88 | BN | 0.25 | 290 | 29 | 700 | — | 440 | 290 | 5 | 38 | 1010 | Invention |
| | | | | | | | | | | | | Example |
| 89 | BO | 0.25 | 290 | 29 | 700 | — | 440 | 300 | 5 | 37 | 1010 | Invention |
| | | | | | | | | | | | | Example |
| 90 | BP | 0.25 | 290 | 29 | 700 | — | 440 | 320 | 5 | 39 | 1010 | Invention |
| | | | | | | | | | | | | Example |

### <Evaluation>

### <<Tissue Observation>>

A test piece for tissue observation was collected from the obtained cold-rolled and annealed sheet. Next, the collected test piece was filled with a resin with a surface (RD surface) perpendicular to the rolling direction as an observation surface, and mirror-finished by colloidal silica polishing. Electron backscatter diffraction (EBSD) measurement was performed on the mirror-finished observation surface to obtain local orientation data. At this time, the step size was set to 5 μm, and the measurement region was set to 50 mm² or more. The size of the measurement region was appropriately adjusted so that the number of crystal grains was 5000 or more in the subsequent analysis. The measurement may be performed in the entire region by one scan, or the scan results of a plurality of times may be combined using the Combo Scan function. Analysis software: OIM Analysis 8 was used to analyze the obtained local orientation data. Prior to data analysis, coordinate rotation processing was performed so as to have A1 axis//rolling direction, A2 axis//direction perpendicular to rolling direction, and A3 axis//sheet surface direction in the sample coordinate system. In addition, granular average data points were selected under the condition of Formula: GCI[&;5.000,2,0.000,0,0,8.0,1,1,1.0,0;]>0.1 with Partition Properties of the analysis software, and data points unsuitable for analysis were excluded. At this time, the number of valid data points was 98% or more.

For the data adjusted as described above, the following analysis was performed with the grain tolerance angle set to 5°, the minimum grain size set to 2, the minimum anti grain size set to 2, and both the multiple rows requirement and the anti-grain multiple rows requirement set to OFF as definitions of crystal grain boundaries. The value of the area average obtained using the grain size (diameter) function for the pretreated data was taken as the average crystal grain size. In addition, using the Crystal Direction function, the area ratio of crystal grains in which <100> and <111> are oriented with respect to the four directions of [A1, A2, A3]=[100], [010], [110], and [1-10] in the sample coordinate system was determined. The tolerance angle at the time of calculating the area ratio was set to 15°. When the area ratio of the crystal grains in which <uvw> is oriented in the [u′v′w′] direction in the sample coordinate system is expressed as S_{<uvw>//[u′v′w′]}, the sum S_{A} of the area ratios of the crystal grains in which <100> is oriented in the rolling direction or the direction perpendicular to the rolling direction can be obtained as S_{A}=S_{<100>//[100]}+S_{<100>/[010}]. The area ratio of the orientation satisfying both <100>//[100] and <100>//[010] is doubly counted. The same applies hereinafter. In the same manner, the sum S_{B} of the area ratios of the crystal grains in which <111> was oriented in the rolling direction or the direction perpendicular to the rolling direction was determined as S_{B}=S_{<111>/[100]}+S_{<111>/[010]}, the sum S_{C} of the area ratios of the crystal grains in which <100> was oriented in a rolling 45° direction and a rolling −45° direction was determined as S_{C}=S_{<100>//[110]}+S_{<100>/[1-10]}, and the sum S_{D} of the area ratios of the crystal grains in which <111> was oriented a rolling 45° direction and a rolling −45° direction was determined as S_{D}=S_{<111>//[110]}+S_{<111>//[1-10]}.

### <<Evaluation of Magnetic Properties>>

From the obtained annealed sheet, a test piece for magnetic measurement having a width of 30 mm and a length of 280 mm, with the length direction as the rolling direction or the direction perpendicular to the rolling direction, was taken, and the magnetic properties of the cold-rolled and annealed sheet were evaluated by the Epstein method in accordance with JIS C2550-1:2011. The evaluation items were saturation magnetic flux density: Bs, magnetic flux density at a magnetic field strength of 5000 A/m: B50, and iron loss W10/800. In addition, for the purpose of examining the anisotropy of magnetic properties, a test piece for magnetic measurement having a width of 30 mm and a length of 280 mm, with the length direction as a rolling 45° direction and a rolling −45° direction, was taken, and the magnetic properties of the cold-rolled and annealed sheet were evaluated by the Epstein method in accordance with JIS C2550-1:2011. The evaluation item was magnetic flux density at a magnetic field strength of 5000 A/m: B50_45°. It was evaluated that the magnetic flux density was good when B50≥1.60 (T) and B50/Bs≥0.82 were satisfied, and it was evaluated that the high frequency iron loss characteristics were good when W10/800≤40 (W/kg) was satisfied. When ΔB50=B50−B50_45°≤0.120 (T) was satisfied, it was evaluated that the anisotropy of the magnetic properties was small.

TABLE 3-1

| | Steel sheet structure | | | | | | | Property | | | | | | |
|---|---|---|---|---|---|---|---|---|---|---|---|---|---|---|
| | Average | | | | | | | | | | | Magnetic | | |
| | crystal | | | | | | | Magnetic | Magnetic | | Iron | flux | | |
| | grain | | | | | SA − | 5SC − | flux | flux | | loss | density | | |
| | size d | SA | SB | SC | SD | SB | SD | density | density | | W_{10/800} | B50_45° | Anisotropy | |
| No. | (μm) | [%] | [%] | [%] | [%] | [%] | [%] | Bs (T) | B50 (T) | B50/Bs | (W/kg) | (T) | Δ B50 (T) | Note |
| 1 | 103 | 19 | 6 | 6 | 25 | 13 | 5 | 1.97 | 1.72 | 0.87 | 30.2 | 1.67 | 0.048 | Invention |
| | | | | | | | | | | | | | | Example |
| 2 | 124 | 13 | 6 | 6 | 25 | 7 | 5 | 1.98 | 1.71 | 0.86 | 29.7 | 1.66 | 0.047 | Invention |
| | | | | | | | | | | | | | | Example |
| 3 | 69 | 17 | 4 | 7 | 27 | 13 | 8 | 1.95 | 1.73 | 0.89 | 28.0 | 1.69 | 0.042 | Invention |
| | | | | | | | | | | | | | | Example |
| 4 | 104 | 19 | 6 | 3 | 11 | 13 | 4 | 2.00 | 1.76 | 0.88 | 31.5 | 1.71 | 0.053 | Invention |
| | | | | | | | | | | | | | | Example |
| 5 | 106 | 20 | 6 | 4 | 11 | 14 | 9 | 1.97 | 1.74 | 0.88 | 29.1 | 1.71 | 0.034 | Invention |
| | | | | | | | | | | | | | | Example |
| 6 | 126 | 17 | 8 | 7 | 27 | 9 | 8 | 1.96 | 1.71 | 0.87 | 27.5 | 1.67 | 0.042 | Invention |
| | | | | | | | | | | | | | | Example |
| 7 | 124 | 16 | 5 | 4 | 13 | 11 | 7 | 1.92 | 1.69 | 0.88 | 25.1 | 1.65 | 0.038 | Invention |
| | | | | | | | | | | | | | | Example |
| 8 | 86 | 16 | 5 | 6 | 26 | 11 | 4 | 1.97 | 1.71 | 0.87 | 29.0 | 1.66 | 0.047 | Invention |
| | | | | | | | | | | | | | | Example |
| 9 | 90 | 19 | 6 | 7 | 28 | 13 | 7 | 1.96 | 1.70 | 0.87 | 28.3 | 1.66 | 0.044 | Invention |
| | | | | | | | | | | | | | | Example |
| 10 | 100 | 13 | 6 | 5 | 16 | 7 | 9 | 1.91 | 1.65 | 0.86 | 25.0 | 1.62 | 0.032 | Invention |
| | | | | | | | | | | | | | | Example |
| 11 | 84 | 15 | 5 | 5 | 21 | 10 | 4 | 1.98 | 1.70 | 0.86 | 29.6 | 1.65 | 0.053 | Invention |
| | | | | | | | | | | | | | | Example |
| 12 | 66 | 12 | 5 | 6 | 21 | 7 | 9 | 2.04 | 1.76 | 0.86 | 47.7 | 1.73 | 0.030 | Compar- |
| | | | | | | | | | | | | | | ative |
| | | | | | | | | | | | | | | Example |
| 13 | 90 | 13 | 6 | 4 | 12 | 7 | 8 | 2.03 | 1.78 | 0.88 | 38.0 | 1.74 | 0.038 | Invention |
| | | | | | | | | | | | | | | Example |
| 14 | 99 | 12 | 5 | 5 | 17 | 7 | 8 | 2.01 | 1.75 | 0.87 | 36.3 | 1.71 | 0.041 | Invention |
| | | | | | | | | | | | | | | Example |
| 15 | 96 | 13 | 6 | 5 | 16 | 7 | 9 | 1.87 | 1.62 | 0.87 | 22.7 | 1.59 | 0.032 | Invention |
| | | | | | | | | | | | | | | Example |
| 16 | 91 | 13 | 6 | 4 | 12 | 7 | 8 | 1.86 | 1.59 | 0.86 | 22.3 | 1.55 | 0.038 | Compar- |
| | | | | | | | | | | | | | | ative |
| | | | | | | | | | | | | | | Example |
| 17 | 112 | 19 | 6 | 3 | 11 | 13 | 4 | 2.03 | 1.75 | 0.86 | 46.9 | 1.71 | 0.042 | Compar- |
| | | | | | | | | | | | | | | ative |
| | | | | | | | | | | | | | | Example |
| 18 | 132 | 19 | 6 | 3 | 11 | 13 | 4 | 2.03 | 1.79 | 0.88 | 36.0 | 1.74 | 0.048 | Invention |
| | | | | | | | | | | | | | | Example |
| 19 | 120 | 21 | 7 | 3 | 11 | 14 | 4 | 1.96 | 1.68 | 0.86 | 35.4 | 1.64 | 0.043 | Invention |
| | | | | | | | | | | | | | | Example |
| 20 | 95 | 19 | 6 | 3 | 11 | 13 | 4 | 1.91 | 1.67 | 0.87 | 42.1 | 1.63 | 0.041 | Compar- |
| | | | | | | | | | | | | | | ative |
| | | | | | | | | | | | | | | Example |
| 21 | 96 | 19 | 7 | 6 | 23 | 12 | 7 | 2.01 | 1.74 | 0.87 | 43.3 | 1.70 | 0.038 | Compar- |
| | | | | | | | | | | | | | | ative |
| | | | | | | | | | | | | | | Example |
| 22 | 104 | 17 | 5 | 7 | 28 | 12 | 7 | 2.01 | 1.77 | 0.88 | 36.1 | 1.73 | 0.039 | Invention |
| | | | | | | | | | | | | | | Example |
| 23 | 136 | 19 | 6 | 7 | 28 | 13 | 7 | 1.92 | 1.67 | 0.87 | 37.6 | 1.63 | 0.042 | Invention |
| | | | | | | | | | | | | | | Example |
| 24 | 93 | 20 | 6 | 7 | 27 | 14 | 8 | 1.86 | 1.65 | 0.89 | 40.7 | 1.61 | 0.038 | Compar- |
| | | | | | | | | | | | | | | ative |
| | | | | | | | | | | | | | | Example |
| 25 | 97 | 19 | 4 | 3 | 11 | 15 | 4 | 1.96 | 1.76 | 0.90 | 27.5 | 1.72 | 0.044 | Invention |
| | | | | | | | | | | | | | | Example |
| 26 | 106 | 21 | 4 | 3 | 11 | 17 | 4 | 1.96 | 1.78 | 0.91 | 27.0 | 1.74 | 0.043 | Invention |
| | | | | | | | | | | | | | | Example |
| 27 | 108 | 18 | 4 | 5 | 13 | 14 | 12 | 1.96 | 1.68 | 0.86 | 29.4 | 1.65 | 0.026 | Invention |
| | | | | | | | | | | | | | | Example |
| 28 | 67 | 17 | 4 | 6 | 16 | 13 | 14 | 1.95 | 1.73 | 0.89 | 28.1 | 1.71 | 0.025 | Invention |
| | | | | | | | | | | | | | | Example |
| 29 | 94 | 19 | 7 | 5 | 20 | 12 | 5 | 1.98 | 1.70 | 0.86 | 30.7 | 1.66 | 0.045 | Invention |
| | | | | | | | | | | | | | | Example |
| 30 | 110 | 18 | 6 | 6 | 25 | 12 | 5 | 1.98 | 1.71 | 0.87 | 30.1 | 1.67 | 0.045 | Invention |
| | | | | | | | | | | | | | | Example |
| 31 | 91 | 20 | 7 | 5 | 20 | 13 | 5 | 1.97 | 1.69 | 0.86 | 30.2 | 1.65 | 0.044 | Invention |
| | | | | | | | | | | | | | | Example |
| 32 | 123 | 19 | 6 | 7 | 30 | 13 | 5 | 1.98 | 1.75 | 0.89 | 29.6 | 1.71 | 0.040 | Invention |
| | | | | | | | | | | | | | | Example |
| 33 | 97 | 20 | 7 | 6 | 25 | 13 | 5 | 1.97 | 1.70 | 0.86 | 30.2 | 1.65 | 0.047 | Invention |
| | | | | | | | | | | | | | | Example |
| 34 | 137 | 17 | 5 | 6 | 25 | 12 | 5 | 1.97 | 1.77 | 0.90 | 28.7 | 1.72 | 0.049 | Invention |
| | | | | | | | | | | | | | | Example |
| 35 | 109 | 17 | 5 | 6 | 25 | 12 | 5 | 1.98 | 1.78 | 0.90 | 29.3 | 1.73 | 0.050 | Invention |
| | | | | | | | | | | | | | | Example |
| 36 | 100 | 13 | 15 | 5 | 15 | −2 | 10 | 1.91 | 1.54 | 0.81 | 42.3 | 1.50 | 0.037 | Compar- |
| | | | | | | | | | | | | | | ative |
| | | | | | | | | | | | | | | Example |
| 37 | 93 | 5 | 6 | 5 | 16 | −1 | 9 | 1.91 | 1.50 | 0.79 | 40.5 | 1.46 | 0.038 | Compar- |
| | | | | | | | | | | | | | | ative |
| | | | | | | | | | | | | | | Example |
| 38 | 117 | 3 | 5 | 3 | 11 | −2 | 4 | 2.00 | 1.55 | 0.77 | 45.4 | 1.50 | 0.047 | Compar- |
| | | | | | | | | | | | | | | ative |
| | | | | | | | | | | | | | | Example |
| 39 | 115 | 9 | 7 | 3 | 11 | 2 | 4 | 2.00 | 1.69 | 0.84 | 35.9 | 1.64 | 0.050 | Invention |
| | | | | | | | | | | | | | | Example |
| 40 | 117 | 9 | 5 | 3 | 11 | 4 | 4 | 2.00 | 1.69 | 0.84 | 35.9 | 1.64 | 0.051 | Invention |
| | | | | | | | | | | | | | | Example |
| 41 | 106 | 17 | 18 | 4 | 13 | −1 | 7 | 1.92 | 1.50 | 0.78 | 41.5 | 1.46 | 0.038 | Compar- |
| | | | | | | | | | | | | | | ative |
| | | | | | | | | | | | | | | Example |
| 42 | 127 | 3 | 5 | 4 | 12 | −2 | 8 | 1.92 | 1.53 | 0.80 | 40.9 | 1.49 | 0.042 | Compar- |
| | | | | | | | | | | | | | | ative |
| | | | | | | | | | | | | | | Example |
| 43 | 95 | 16 | 17 | 8 | 32 | −1 | 8 | 2.01 | 1.61 | 0.80 | 46.1 | 1.57 | 0.037 | Compar- |
| | | | | | | | | | | | | | | ative |
| | | | | | | | | | | | | | | Example |
| 44 | 96 | 15 | 14 | 7 | 28 | 1 | 7 | 2.01 | 1.66 | 0.83 | 38.1 | 1.62 | 0.036 | Invention |
| | | | | | | | | | | | | | | Example |
| 45 | 129 | 15 | 11 | 8 | 33 | 4 | 7 | 2.01 | 1.71 | 0.85 | 37.2 | 1.67 | 0.042 | Invention |
| | | | | | | | | | | | | | | Example |
| 46 | 53 | 17 | 4 | 3 | 11 | 13 | 4 | 1.96 | 1.70 | 0.87 | 42.9 | 1.65 | 0.048 | Compar- |
| | | | | | | | | | | | | | | ative |
| | | | | | | | | | | | | | | Example |
| 47 | 62 | 17 | 4 | 3 | 11 | 13 | 4 | 1.96 | 1.69 | 0.86 | 37.4 | 1.65 | 0.041 | Invention |
| | | | | | | | | | | | | | | Example |
| 48 | 193 | 18 | 4 | 3 | 11 | 14 | 4 | 1.96 | 1.72 | 0.88 | 36.8 | 1.68 | 0.043 | Invention |
| | | | | | | | | | | | | | | Example |
| 49 | 232 | 18 | 4 | 3 | 11 | 14 | 4 | 1.96 | 1.68 | 0.86 | 43.3 | 1.64 | 0.045 | Compar- |
| | | | | | | | | | | | | | | ative |
| | | | | | | | | | | | | | | Example |
| 50 | 88 | 25 | 6 | 5 | 26 | 19 | −1 | 1.97 | 1.74 | 0.88 | 29.6 | 1.60 | 0.139 | Invention |
| | | | | | | | | | | | | | | Example |
| 51 | 106 | 25 | 6 | 5 | 24 | 19 | 1 | 1.97 | 1.76 | 0.89 | 29.3 | 1.69 | 0.070 | Invention |
| | | | | | | | | | | | | | | Example |
| 52 | 122 | 25 | 7 | 4 | 17 | 18 | 3 | 1.97 | 1.75 | 0.89 | 29.5 | 1.70 | 0.055 | Invention |
| | | | | | | | | | | | | | | Example |
| 53 | 116 | 24 | 6 | 5 | 27 | 18 | −2 | 1.97 | 1.73 | 0.88 | 29.8 | 1.60 | 0.127 | Invention |
| | | | | | | | | | | | | | | Example |
| 54 | 138 | 24 | 6 | 4 | 20 | 18 | 0 | 1.97 | 1.73 | 0.88 | 29.8 | 1.63 | 0.096 | Invention |
| | | | | | | | | | | | | | | Example |
| 55 | 139 | 23 | 6 | 4 | 21 | 17 | −1 | 1.97 | 1.75 | 0.89 | 29.5 | 1.62 | 0.131 | Invention |
| | | | | | | | | | | | | | | Example |
| 56 | 99 | 25 | 6 | 5 | 24 | 19 | 1 | 1.97 | 1.75 | 0.89 | 29.5 | 1.68 | 0.067 | Invention |
| | | | | | | | | | | | | | | Example |
| 57 | 94 | 19 | 6 | 6 | 25 | 13 | 5 | 1.97 | 1.73 | 0.88 | 30.0 | 1.69 | 0.045 | Invention |
| | | | | | | | | | | | | | | Example |

Note)
Underlined part is outside scope of the invention

TABLE 3-2

| | Steel sheet structure | | | | | | | Property | | | | | | |
|---|---|---|---|---|---|---|---|---|---|---|---|---|---|---|
| | Average | | | | | | | | | | | Magnetic | | |
| | crystal | | | | | | | Magnetic | Magnetic | | Iron | flux | | |
| | grain | | | | | SA − | 5SC − | flux | flux | | loss | density | | |
| | size d | SA | SB | SC | SD | SB | SD | density | density | | W_{10/800} | B50_45° | Anisotropy | |
| No. | (μm) | [%] | [%] | [%] | [%] | [%] | [%] | Bs (T) | B50 (T) | B50/Bs | (W/kg) | (T) | Δ B50 (T) | Note |
| 58 | 98 | 19 | 4 | 3 | 11 | 15 | 4 | 1.95 | 1.78 | 0.91 | 27.1 | 1.73 | 0.051 | Invention |
| | | | | | | | | | | | | | | Example |
| 59 | 103 | 18 | 4 | 5 | 12 | 14 | 13 | 1.95 | 1.67 | 0.85 | 28.8 | 1.64 | 0.028 | Invention |
| | | | | | | | | | | | | | | Example |
| 60 | 107 | 19 | 7 | 7 | 29 | 12 | 6 | 1.97 | 1.68 | 0.85 | 30.8 | 1.64 | 0.038 | Invention |
| | | | | | | | | | | | | | | Example |
| 61 | 99 | 19 | 6 | 6 | 25 | 13 | 5 | 1.97 | 1.68 | 0.85 | 30.5 | 1.64 | 0.040 | Invention |
| | | | | | | | | | | | | | | Example |
| 62 | 109 | 21 | 7 | 6 | 25 | 14 | 5 | 1.97 | 1.74 | 0.88 | 29.6 | 1.69 | 0.047 | Invention |
| | | | | | | | | | | | | | | Example |
| 63 | 139 | 17 | 5 | 5 | 20 | 12 | 5 | 1.97 | 1.70 | 0.86 | 30.2 | 1.66 | 0.044 | Invention |
| | | | | | | | | | | | | | | Example |
| 64 | 120 | 19 | 6 | 6 | 25 | 13 | 5 | 1.97 | 1.72 | 0.87 | 29.9 | 1.67 | 0.046 | Invention |
| | | | | | | | | | | | | | | Example |
| 65 | 116 | 21 | 7 | 6 | 25 | 14 | 5 | 1.97 | 1.77 | 0.90 | 29.2 | 1.72 | 0.046 | Invention |
| | | | | | | | | | | | | | | Example |
| 66 | 120 | 20 | 7 | 6 | 25 | 13 | 5 | 1.97 | 1.76 | 0.89 | 29.3 | 1.72 | 0.040 | Invention |
| | | | | | | | | | | | | | | Example |
| 67 | 113 | 11 | 5 | 7 | 30 | 6 | 5 | 1.98 | 1.68 | 0.85 | 30.2 | 1.64 | 0.038 | Invention |
| | | | | | | | | | | | | | | Example |
| 68 | 102 | 14 | 7 | 5 | 20 | 7 | 5 | 1.98 | 1.74 | 0.88 | 29.3 | 1.70 | 0.039 | Invention |
| | | | | | | | | | | | | | | Example |
| 69 | 96 | 13 | 6 | 6 | 25 | 7 | 5 | 1.98 | 1.70 | 0.86 | 29.9 | 1.66 | 0.040 | Invention |
| | | | | | | | | | | | | | | Example |
| 70 | 112 | 13 | 5 | 5 | 20 | 8 | 5 | 1.98 | 1.68 | 0.85 | 30.2 | 1.64 | 0.045 | Invention |
| | | | | | | | | | | | | | | Example |
| 71 | 91 | 20 | 7 | 4 | 11 | 13 | 9 | 1.97 | 1.70 | 0.86 | 29.7 | 1.67 | 0.032 | Invention |
| | | | | | | | | | | | | | | Example |
| 72 | 117 | 19 | 5 | 4 | 11 | 14 | 9 | 1.97 | 1.68 | 0.85 | 29.9 | 1.64 | 0.040 | Invention |
| | | | | | | | | | | | | | | Example |
| 73 | 88 | 18 | 5 | 4 | 12 | 13 | 8 | 1.97 | 1.71 | 0.87 | 29.5 | 1 68 | 0.033 | Invention |
| | | | | | | | | | | | | | | Example |
| 74 | 71 | 19 | 6 | 4 | 11 | 13 | 9 | 1.97 | 1.69 | 0.86 | 29.8 | 1.66 | 0.035 | Invention |
| | | | | | | | | | | | | | | Example |
| 75 | 85 | 19 | 6 | 4 | 11 | 13 | 9 | 1.97 | 1.69 | 0.86 | 29.8 | 1.66 | 0.035 | Invention |
| | | | | | | | | | | | | | | Example |
| 76 | 77 | 19 | 6 | 4 | 12 | 13 | 8 | 1.97 | 1.75 | 0.89 | 29.0 | 1.72 | 0.031 | Invention |
| | | | | | | | | | | | | | | Example |
| 77 | 85 | 18 | 5 | 4 | 11 | 13 | 9 | 1.97 | 1.73 | 0.88 | 29.2 | 1.70 | 0.032 | Invention |
| | | | | | | | | | | | | | | Example |
| 78 | 116 | 21 | 7 | 4 | 10 | 14 | 10 | 1.97 | 1.70 | 0.86 | 29.7 | 1.67 | 0.035 | Invention |
| | | | | | | | | | | | | | | Example |
| 79 | 75 | 21 | 6 | 4 | 10 | 15 | 10 | 1.97 | 1.73 | 0.88 | 29.2 | 1.70 | 0.030 | Invention |
| | | | | | | | | | | | | | | Example |
| 80 | 91 | 19 | 6 | 4 | 11 | 13 | 9 | 1.97 | 1.70 | 0.86 | 29.7 | 1.66 | 0.038 | Invention |
| | | | | | | | | | | | | | | Example |
| 81 | 133 | 18 | 9 | 7 | 27 | 9 | 8 | 1.96 | 1.71 | 0.87 | 27.5 | 1.68 | 0.032 | Invention |
| | | | | | | | | | | | | | | Example |
| 82 | 90 | 18 | 9 | 7 | 27 | 9 | 8 | 1.96 | 1.72 | 0.88 | 27.4 | 1.68 | 0.042 | Invention |
| | | | | | | | | | | | | | | Example |
| 83 | 100 | 17 | 9 | 8 | 32 | 9 | 8 | 1.96 | 1.68 | 0.86 | 27.9 | 1.65 | 0.034 | Invention |
| | | | | | | | | | | | | | | Example |
| 84 | 140 | 16 | 7 | 6 | 22 | 8 | 8 | 1.96 | 1.68 | 0.86 | 27.9 | 1.64 | 0.041 | Invention |
| | | | | | | | | | | | | | | Example |
| 85 | 113 | 18 | 9 | 6 | 23 | 9 | 7 | 1.96 | 1.71 | 0.87 | 27.5 | 1.67 | 0.042 | Invention |
| | | | | | | | | | | | | | | Example |
| 86 | 97 | 16 | 7 | 7 | 27 | 9 | 8 | 1.96 | 1.70 | 0.87 | 27.7 | 1.66 | 0.038 | Invention |
| | | | | | | | | | | | | | | Example |
| 87 | 101 | 16 | 6 | 4 | 13 | 10 | 7 | 1.92 | 1.75 | 0.91 | 24.4 | 1.71 | 0.040 | Invention |
| | | | | | | | | | | | | | | Example |
| 88 | 124 | 15 | 4 | 4 | 12 | 11 | 8 | 1.92 | 1.77 | 0.92 | 24.2 | 1.73 | 0.039 | Invention |
| | | | | | | | | | | | | | | Example |
| 89 | 96 | 17 | 5 | 4 | 12 | 12 | 8 | 1.92 | 1.73 | 0.90 | 24.7 | 1.69 | 0.042 | Invention |
| | | | | | | | | | | | | | | Example |
| 90 | 100 | 17 | 6 | 4 | 13 | 11 | 7 | 1.92 | 1.75 | 0.91 | 24.4 | 1.72 | 0.035 | Invention |
| | | | | | | | | | | | | | | Example |

From the results of Tables 3-1 and 2, it can be seen that the non-oriented electrical steel sheets according to aspects of the present invention all have excellent magnetic flux density and excellent high-frequency iron loss characteristics. Further, when the steel sheet was subjected to stress-relief annealing for the purpose of recovering iron loss reduction due to strain at the time of punching, there was no influence on the effect according to aspects of the present invention, and both excellent magnetic flux density and excellent iron loss characteristics were achieved.

### INDUSTRIAL APPLICABILITY

According to aspects of the present invention, a non-oriented electrical steel sheet having a high magnetic flux density and a high-frequency low iron loss without causing a decrease in saturation magnetic flux density and a decrease in productivity, and a method for manufacturing the same can be provided.

1-7. (canceled)

8. A non-oriented electrical steel sheet comprising, by mass %,
C: 0.010% or less,
Si: 1.0% or more and 5.0% or less,
Mn: 0.05% or more and 5.0% or less,
P: 0.1% or less,
S: 0.01% or less,
Al: 3.0% or less,
N: 0.005% or less, and
the balance being Fe and inevitable impurities,
wherein an average crystal grain size is 60 μm or more and 200 μm or less, and
a sum S_{A} of area ratios of crystal grains with <100> oriented in a rolling direction or a direction perpendicular to the rolling direction and a sum S_{B} of area ratios of crystal grains with <111> oriented in the rolling direction or the direction perpendicular to the rolling direction satisfy S_{A}−S_{B}≥0.

9. The non-oriented electrical steel sheet according to claim 8, wherein a sum S_{C} of area ratios of crystal grains with <100> oriented in a rolling 45° direction and a rolling −45° direction and a sum S_{D} of area ratios of crystal grains with <111> oriented in the rolling 45° direction and the rolling −45° direction satisfy 5×S_{C}−S_{D}≥0.

10. The non-oriented electrical steel sheet according to claim 8, further comprising Co in an amount of 0.0005% or more and 0.0050% or less by mass %.

11. The non-oriented electrical steel sheet according to claim 9, further comprising Co in an amount of 0.0005% or more and 0.0050% or less by mass %.

12. The non-oriented electrical steel sheet according to claim 8, further comprising Zn in an amount of 0.0005% or more and 0.0050% or less by mass %.

13. The non-oriented electrical steel sheet according to claim 9, further comprising Zn in an amount of 0.0005% or more and 0.0050% or less by mass %.

14. The non-oriented electrical steel sheet according to claim 10, further comprising Zn in an amount of 0.0005% or more and 0.0050% or less by mass %.

15. The non-oriented electrical steel sheet according to claim 11, further comprising Zn in an amount of 0.0005% or more and 0.0050% or less by mass %.

16. The non-oriented electrical steel sheet according to claim 8, further comprising, by mass %, at least one component selected from Groups A to D shown below and one or two or more selected from the group selected from Cu: 0% or more and 0.5% or less, Ni: 0% or more and 0.5% or less, W: 0% or more and 0.05% or less, Ti: 0% or more and 0.005% or less, Nb: 0% or more and 0.005% or less, V: 0% or more and 0.010% or less, Ta:
0% or more and 0.002% or less, B: 0% or more and 0.002% or less, Ga: 0% or more and 0.005% or less, Pb: 0% or more and 0.002% or less, As: 0% or more and 0.05% or less, and Ge: 0% or more and 0.05% or less,
Group A; Mo: 0.01% or more and 0.20% or less
Group B; Cr: 0.1% or more and 5.0% or less
Group C; Any one or two or more of Ca: 0.001% or more and 0.10% or less, Mg: 0.001% or more and 0.10% or less, and REM: 0.001% or more and 0.10% or less
Group D; Any one or two of Sn: 0.001% or more and 0.20% or less and Sb: 0.001% or more and 0.20% or less.

17. The non-oriented electrical steel sheet according to claim 9, further comprising, by mass %, at least one component selected from Groups A to D shown below and one or two or more selected from the group selected from Cu: 0% or more and 0.5% or less, Ni: 0% or more and 0.5% or less, W: 0% or more and 0.05% or less, Ti: 0% or more and 0.005% or less, Nb: 0% or more and 0.005% or less, V: 0% or more and 0.010% or less, Ta: 0% or more and 0.002% or less, B: 0% or more and 0.002% or less, Ga: 0% or more and 0.005% or less, Pb: 0% or more and 0.002% or less, As: 0% or more and 0.05% or less, and Ge: 0% or more and 0.05% or less,
Group A; Mo: 0.01% or more and 0.20% or less
Group B; Cr: 0.1% or more and 5.0% or less
Group C; Any one or two or more of Ca: 0.001% or more and 0.10% or less, Mg: 0.001% or more and 0.10% or less, and REM: 0.001% or more and 0.10% or less
Group D; Any one or two of Sn: 0.001% or more and 0.20% or less and Sb: 0.001% or more and 0.20% or less.

18. The non-oriented electrical steel sheet according to claim 10, further comprising, by mass %, at least one component selected from Groups A to D shown below and one or two or more selected from the group selected from Cu: 0% or more and 0.5% or less, Ni: 0% or more and 0.5% or less, W: 0% or more and 0.05% or less, Ti: 0% or more and 0.005% or less, Nb: 0% or more and 0.005% or less, V: 0% or more and 0.010% or less, Ta: 0% or more and 0.002% or less, B: 0% or more and 0.002% or less, Ga: 0% or more and 0.005% or less, Pb: 0% or more and 0.002% or less, As: 0% or more and 0.05% or less, and Ge: 0% or more and 0.05% or less,
Group A; Mo: 0.01% or more and 0.20% or less
Group B; Cr: 0.1% or more and 5.0% or less
Group C; Any one or two or more of Ca: 0.001% or more and 0.10% or less, Mg: 0.001% or more and 0.10% or less, and REM: 0.001% or more and 0.10% or less
Group D; Any one or two of Sn: 0.001% or more and 0.20% or less and Sb: 0.001% or more and 0.20% or less.

19. The non-oriented electrical steel sheet according to claim 11, further comprising, by mass %, at least one component selected from Groups A to D shown below and one or two or more selected from the group selected from Cu: 0% or more and 0.5% or less, Ni: 0% or more and 0.5% or less, W: 0% or more and 0.05% or less, Ti: 0% or more and 0.005% or less, Nb: 0% or more and 0.005% or less, V: 0% or more and 0.010% or less, Ta: 0% or more and 0.002% or less, B: 0% or more and 0.002% or less, Ga: 0% or more and 0.005% or less, Pb: 0% or more and 0.002% or less, As: 0% or more and 0.05% or less, and Ge: 0% or more and 0.05% or less,
Group A; Mo: 0.01% or more and 0.20% or less
Group B; Cr: 0.1% or more and 5.0% or less
Group C; Any one or two or more of Ca: 0.001% or more and 0.10% or less, Mg: 0.001% or more and 0.10% or less, and REM: 0.001% or more and 0.10% or less Group D; Any one or two of Sn: 0.001% or more and 0.20% or less and Sb: 0.001% or more and 0.20% or less.

20. The non-oriented electrical steel sheet according to claim 12, further comprising, by mass %, at least one component selected from Groups A to D shown below and one or two or more selected from the group selected from Cu: 0% or more and 0.5% or less, Ni: 0% or more and 0.5% or less, W: 0% or more and 0.05% or less, Ti: 0% or more and 0.005% or less, Nb: 0% or more and 0.005% or less, V: 0% or more and 0.010% or less, Ta: 0% or more and 0.002% or less, B: 0% or more and 0.002% or less, Ga: 0% or more and 0.005% or less, Pb: 0% or more and 0.002% or less, As: 0% or more and 0.05% or less, and Ge: 0% or more and 0.05% or less,
Group A; Mo: 0.01% or more and 0.20% or less
Group B; Cr: 0.1% or more and 5.0% or less
Group C; Any one or two or more of Ca: 0.001% or more and 0.10% or less, Mg: 0.001% or more and 0.10% or less, and REM: 0.001% or more and 0.10% or less
Group D; Any one or two of Sn: 0.001% or more and 0.20% or less and Sb: 0.001% or more and 0.20% or less.

21. The non-oriented electrical steel sheet according to claim 13, further comprising, by mass %, at least one component selected from Groups A to D shown below and one or two or more selected from the group selected from Cu: 0% or more and 0.5% or less, Ni: 0% or more and 0.5% or less, W: 0% or more and 0.05% or less, Ti: 0% or more and 0.005% or less, Nb: 0% or more and 0.005% or less, V: 0% or more and 0.010% or less, Ta: 0% or more and 0.002% or less, B: 0% or more and 0.002% or less, Ga: 0% or more and 0.005% or less, Pb: 0% or more and 0.002% or less, As: 0% or more and 0.05% or less, and Ge: 0% or more and 0.05% or less,
Group A; Mo: 0.01% or more and 0.20% or less
Group B; Cr: 0.1% or more and 5.0% or less
Group C; Any one or two or more of Ca: 0.001% or more and 0.10% or less, Mg: 0.001% or more and 0.10% or less, and REM: 0.001% or more and 0.10% or less
Group D; Any one or two of Sn: 0.001% or more and 0.20% or less and Sb: 0.001% or more and 0.20% or less.

22. The non-oriented electrical steel sheet according to claim 14, further comprising, by mass %, at least one component selected from Groups A to D shown below and one or two or more selected from the group selected from Cu: 0% or more and 0.5% or less, Ni: 0% or more and 0.5% or less, W: 0% or more and 0.05% or less, Ti: 0% or more and 0.005% or less, Nb: 0% or more and 0.005% or less, V: 0% or more and 0.010% or less, Ta: 0% or more and 0.002% or less, B: 0% or more and 0.002% or less, Ga: 0% or more and 0.005% or less, Pb: 0% or more and 0.002% or less, As: 0% or more and 0.05% or less, and Ge: 0% or more and 0.05% or less,
Group A; Mo: 0.01% or more and 0.20% or less
Group B; Cr: 0.1% or more and 5.0% or less
Group C; Any one or two or more of Ca: 0.001% or more and 0.10% or less, Mg: 0.001% or more and 0.10% or less, and REM: 0.001% or more and 0.10% or less
Group D; Any one or two of Sn: 0.001% or more and 0.20% or less and Sb: 0.001% or more and 0.20% or less.

23. The non-oriented electrical steel sheet according to claim 15, further comprising, by mass %, at least one component selected from Groups A to D shown below and one or two or more selected from the group selected from Cu: 0% or more and 0.5% or less, Ni: 0% or more and 0.5% or less, W: 0% or more and 0.05% or less, Ti: 0% or more and 0.005% or less, Nb: 0% or more and 0.005% or less, V: 0% or more and 0.010% or less, Ta: 0% or more and 0.002% or less, B: 0% or more and 0.002% or less, Ga: 0% or more and 0.005% or less, Pb: 0% or more and 0.002% or less, As: 0% or more and 0.05% or less, and Ge: 0% or more and 0.05% or less,
Group A; Mo: 0.01% or more and 0.20% or less
Group B; Cr: 0.1% or more and 5.0% or less
Group C; Any one or two or more of Ca: 0.001% or more and 0.10% or less, Mg: 0.001% or more and 0.10% or less, and REM: 0.001% or more and 0.10% or less
Group D; Any one or two of Sn: 0.001% or more and 0.20% or less and Sb: 0.001% or more and 0.20% or less.

24. A method for manufacturing the non-oriented electrical steel sheet according to claim 8, the method comprising:
(a) subjecting a steel material having a composition of the non-oriented electrical steel sheet to hot rolling to obtain a hot rolled sheet;
(b) subjecting the hot-rolled sheet to hot-rolled sheet annealing as necessary;
(c) subjecting the hot-rolled sheet and the hot-rolled sheet subjected to the hot-rolled sheet annealing to pickling;
(d) subjecting the hot-rolled sheet subjected to the pickling to cold rolling to obtain a cold-rolled sheet; and
(e) heating the cold-rolled sheet to an annealing temperature of T₂ of 875° C. or higher and 1050° C. or lower and cooling the sheet to obtain a cold-rolled and annealed sheet under conditions of an average temperature rising rate V₁ of 50° C./s or more, from 200° C. to a holding temperature T1 of 400° C. or higher and 600° C. or lower,
a holding time t of 1 second or more and 10 seconds or less, at the holding temperature T₁, and
an average temperature rising rate V₂ of 15° C./s or more, from the holding temperature T₁ to 750° C.

25. The method for manufacturing a non-oriented electrical steel sheet according to claim 24, wherein (d) is performed under conditions of a work roll diameter of a final pass of 150 mm ϕ or more, a rolling reduction ratio of the final pass of 15% or more, and a strain rate of the final pass of 100 s⁻¹ or more and 1300 s⁻¹ or less.
